(19) United States
(12) Patent Application Publication
(10) Pub. No.: US 2013/0041479 A1
(43) Pub. Date: Feb. 14, 2013

(54) AUTOMATED CONTROL SYSTEM AND SUPERVISOR SCHEDULER USABLE WITH SAME

(71) Applicants: Shuo Zhang, Astoria, NY (US); Chandra Sekhar Inturi, Forest Hills, NY (US); Christopher LaBello, Brooklyn, NY (US); Alan M. Ganz, Scarsdale, NY (US)

(72) Inventors: Shuo Zhang, Astoria, NY (US); Chandra Sekhar Inturi, Forest Hills, NY (US); Christopher LaBello, Brooklyn, NY (US); Alan M. Ganz, Scarsdale, NY (US)

(21) Appl. No.: 13/225,395

(22) Filed: Sep. 2, 2011

Related U.S. Application Data
(63) Continuation-in-part of application No. 13/007,512, filed on Jan. 14, 2011, now abandoned.
Application No. 13/007,512 is a continuation-in-part of application No. 12/791,778, filed on Jun. 1, 2010, now abandoned.
Application No. 12/791,778 is a continuation of application No. 12/580,245, filed on Oct. 15, 2009, now abandoned.
(60) Provisional application No. 61/105,719, filed on Oct. 15, 2008.
(60) Provisional application No. 61/105,778, filed on Oct. 15, 2008.

(51) Int. Cl. G05B 15/02

(52) U.S. Cl. 700/17

(57) ABSTRACT

A computerized method of offering a comprehensive control system for varied kinds of manufactures, including: providing a computer graphical user interface having the static model of hardware systems, information and status of the control system and context of the automation procedure commands; providing a hardware database containing 1) port database including all ports of a controller connecting to devices, 2) a device database including information, operation methods, events of all devices connected to the controller, 3) a system database including information and configuration of all systems that controller controls; providing a dictionary containing word pairs that define operations and status of every device; providing a background worker responsible for refreshing data from port database. Computer systems configured to perform the method.

This application is a continuation-in-part of application Ser. No. 13/007,512, filed on Jan. 14, 2011, which is a continuation-in-part of application Ser. No. 12/791,778 filed on Jun. 1, 2010, which is a continuation of application Ser. No. 12/580,245 filed on Oct. 15, 2009, now abandoned, which in turn claims priority under 35 U.S.C. 119(e) from provisional application Ser. Nos. 61/105,719 and 61/105,778 which were both filed on Oct. 15, 2008. All of these documents are incorporated herein by reference, in their entireties, for all purposes.

### BACKGROUND

1. Field of the Invention

The present invention relates to industrial control apparatus and methods and to the manner in which such apparatus and methods may be utilized for more efficient industrial production. More specifically, the present invention relates to graphical user interfaces and computerized systems for industrial control and manufacture. The invention also relates to those apparatus and methods that may be used for numerous other automation opportunities including laboratory sample handling, paint and plastic spray automation and most routine logic control functions. Significantly, the present inventions provide unique opportunities for large savings in energy during chemical processing.

2. Background Art

Many factory PLC-type control systems are available in the market but nearly all of them have a critical defect, lack of flexibility. They are intended to work optimally when configured and programmed for specific tasks; alterations of the steps in the tasks (the “Recipe”) generally demand modifications of the program and/or the electromechanical configuration. Such changes are typically the province of specialists, who are frequently engineers and electricians, and are not commonly achievable by routine factory workers. Frequently however, manufactures require, or at least would prefer, a flexible control system so that they can reconfigure quickly and easily for a range of unanticipated needs. For example, a chemical producer manufacturing one type of cosmetic may have the opportunity to produce a new product, but one that requires a different sequence of steps and even additional features such as more pumps and tanks into which to direct ingredients, in-process mixes or finished products. Such a change of recipe, if it could be done with existing non-specialized, staff would be of great commercial value to the factory.

Thus, modern industrial manufactures depend on computerized control systems. A typical computerized control system contains a controller responsible for reading information from devices, sending information to devices and other system operations; and a GUI to show information of devices and system statuses to users and to provide operations of these devices. Some automation control systems also provide methods to run automation process. For example, a typical PLC system contains a PLC, as a controller and an HMI as a GUI. The user can control devices from the HMI and get some information such as speed of motors, temperature, etc. However, depending on different industrial environments, different types of manufactures, different devices and different controllers, control systems are usually quite different. Users cannot find a universal control system to fit most of the controllers and devices in the market. If a chemical plant has one hundred tanks, each of them has a PLC, and the user needs to write one hundred HMI programs.

Another issue is that a controller is designed for a particular GUI and automation process. Also using the example of a PLC, one HMI program designed for a specific model of PLC, such as, for example the Allen-Bradley SLC-504, cannot run simply at another model of PLC, such as, for example, the Siemens S7-200. Because the controller is responsible for running automation process and dealing with conditions, subroutines, etc, the automation process depends very heavily on the controller. If a chemical plant has three kinds of PLC, for each automation process, three different recipes must be written. Assuming the plant has three hundred different process, there will be nine hundred different recipes. This situation is fraught with difficulty.

Recently the PAC (Programmable Automation Controller) provides a computer based control system and allows the user to write his own automation process program. However, PAC's lack flexibility and simplicity. One issue is that user must learn how to write such programs; to some degree, it is similar to Ladder Logic. Another issue is the control system is always designed for a specific controller, so these programs are very difficult to run on other controllers.

Even if the problems mentioned above are overcome, it is often difficult for a chemical or other production facility to properly schedule and supervise a particular production run, or even more significantly, numerous production runs for a variety of customers. Raw materials, equipment and personnel must all be available at the right time. Further, the production process must be monitored, and information must often be supplied to customers to assure them that the products they need, will be available on time.

Often, it is difficult for factory personnel or even engineers to conceive of the manner in which such control systems should be designed and set up. It would be useful if plant configuration could be made available to a remote location so that a central design facility could acquire the information and propose solutions.

Finally, while some chemical processing facilities are associated with large companies, the majority are associated with small businesses. The United States Department of Labor web site, in March of 2006, indicated that nearly eighty percent of chemical manufacturing jobs are in businesses having fewer than fifty employees. When the fact is considered that most jobs are created by small businesses, especially in the United States, there is a tremendous potential for creating a large number of new jobs, if small businesses can keep costs under control by utilizing efficient automation to offset otherwise rising costs due to possibly higher taxes and an increasing morass of government regulations and mandates.

### SUMMARY

The present invention relates to various aspects for control systems and automation processes.

In one aspect of the invention, a new computerized method allows a user to control different systems in universal software.

In another aspect of the invention, this computerized method allows a user to edit their own automation processes and run them on different systems.

These objectives and many others are achieved in accordance with the invention by reference to the description and claims set forth below.

### BRIEF DESCRIPTION OF THE DRAWINGS

The foregoing aspects and other features of the present invention are explained in the following description, taken in connection with the accompanying drawings, wherein:

FIG. 1 is a computer screen showing the graphical user interface of the main windows of the illustrated embodiment including a schematic of a process tank and associated hardware that is controlled to perform a chemical process.

FIG. 2 is similar to FIG. 1, but has superimposed thereon a simple graphical user interface for the selection of motor speed for a two-speed motor for controlling rate of injection into the process tank.

FIG. 3 is similar to FIG. 1, but has superimposed thereon a simple graphical user interface for the selection of the extent of valve opening for controlling injection into the process tank.

FIG. 4 is similar to FIG. 1, but has superimposed thereon a simple graphical user interface for determining whether a motor for rotating a rotating device in the process tank is turned on, and its frequency of rotation.

FIG. 5 is similar to FIG. 1, but has superimposed thereon a property chart window for displaying parameters of the process being run in the process tank, as a function of time.

FIG. 6 is a screen shot of the recipe maker.

FIG. 7 shows a message popup.

FIG. 8 shows a message in the recipe field.

FIG. 9 shows a heating popup.

FIG. 10 shows a heating set point in the recipe field.

FIG. 11 shows a heating popup and an action to start.

FIG. 12 shows a heating start in the recipe field.

FIG. 13 shows a sweep popup.

FIG. 14 shows a sweep set point in the recipe field.

FIG. 15 shows a sweep popup and an action to start.

FIG. 16 shows a sweep start in the recipe field.

FIG. 17 shows a sweep popup and a time span specified.

FIG. 18 shows a sweep time span in the recipe field.

FIG. 19 is a schematic representation of the overall architecture of the computerized method entitled UDI Program.

FIG. 20 is a schematic representation of the architecture of the Core of FIG. 19 including the Engine and the several Managers.

FIG. 21 is a method of linking the abstract concepts of FIG. 19 to specific hardware.

FIG. 22 is a flowchart showing the process of initializing the engine of FIG. 20.

FIG. 23 is a representation of the interaction of the controller program and the system manager

FIG. 24 is flowchart showing the process of system recovery from a fault.

FIG. 25 is Square waves with different duty cycles.

FIG. 26 is the flowchart showing using Wizard to configure the UDI and control system.

FIG. 27 is a login page for all users (Supervisor, Client & Admin) of the Scheduler Supervisor.

FIG. 28 is a supervisor main interface.

FIG. 29 represents a scheduling recipe at the supervisor.

FIG. 30 illustrates the manner of producing a Recipe at the supervisor in the Supervisor Scheduler Interface.

FIG. 31 illustrates recipe validation controls at the supervisor.

FIG. 32 illustrates a batch monitoring window at the supervisor.

FIG. 33 illustrates an add tool frame at the supervisor.

FIG. 33A illustrates an edit tool frame of the supervisor

FIG. 34 illustrates update and cancel tool frame at the supervisor.

FIG. 35 illustrates the GUI Wizard Main Settings Window at the Supervisor

FIG. 36 illustrates the GUI Wizard for defining values and motors for a specific tank at the supervisor.

FIG. 36-A illustrates the GUI Wizard for choosing an image for valves and motors at the supervisor.

FIG. 37 illustrates the variable frequency drive configuration at the supervisor.

FIG. 38 illustrates a PID temperature control drive configuration for start/stop at the supervisor.

FIG. 38A illustrates a PID temperature control drive configuration for set-point at the supervisor.

FIG. 39 illustrates a historical database query window at the supervisor.

FIG. 40 illustrates a batch monitoring window at the client.

FIG. 41 illustrates remote activation of camera at the supervisor

FIG. 42 illustrates the overall architecture of the cloud supervisor scheduler.

FIG. 43 illustrates the supervisor/client communication architecture.

FIG. 44 illustrates the worker communication architecture.

FIG. 45 illustrates layers inside the cloud.

FIG. 46 illustrates data transfer/update between UDI, LocalSS and WebSS.

FIG. 47 illustrates internal database structure of WebSS

FIG. 48 is a flow chart of operation of a login page of the supervisor scheduler.

FIG. 49 illustrates the principal features of the supervisor scheduler.

FIG. 50 is a 24/7 background process flowchart at the cloud.

FIG. 51 is a flow chart of the Scheduling Manufacturing Procedure at the Supervisor Control Cloud.

FIG. 52 is a flow chart of an instant messaging system at the cloud.

FIG. 53 is a flow chart of a real time global camera viewing system at the cloud supervisor scheduler

FIG. 54 is a flow chart of a real time global status view of manufacturing procedure at the cloud.

FIG. 55 is a flow chart of the GUI Wizard and user customized icons at the supervisor scheduler.

FIG. 56 is a flow chart of the recipe wizard at the supervisor cloud.

### DETAILED DESCRIPTION OF THE PREFERRED EMBODIMENTS

Although the present invention will be described with reference to the embodiments shown in the drawings, it should be understood that the present invention can be embodied in many alternate forms of embodiments. In addition, any suitable size types of elements or materials could be used.

The description below is divided into five sections. The first section, entitled Overview, presents aspects of the control system during routine use. The second section, entitled, Architecture, presents detailed information about the processing and computations that underlie the inventions. The third section, entitled Implementation, presents detailed examples of several embodiments of the subject matter mentioned in the Principles section. The fourth section, entitled applications, presents disparate examples of the utility of the devices enabled by the methods of the application section. The fifth section, entitled Supervisor Scheduler, presents methods of conveniently scheduling and observing the embodiments of the prior four sections.

### 1.0 Overview

### 1.1 Control System

In the following description, numerous details are set forth to provide a more thorough explanation of the present invention. Because the present invention is universal and can be applied to various kinds of environments and systems, in the description below an example in chemical manufacture is presented to demonstrate the operation of the system. By universal is meant that the computer program in the PC is able to work with a wide suite of controllers ranging from PLC devices of most manufacture, to Field IO products, to Data Acquisition Boards, to specialized process chips, e.g. the Arduino chip.

The program that is the basis of the invention is called “the UDI” or the “UDI Program”. This name evolved from the initial hardware embodiment, called “the DART”. As it developed that multiple processors, not just the one first tried, could be enabled in the DART, and that these embodiments used virtually the same PC software, the name Universal DART Interface or UDI became synonymous with the operational code.

### 1.2 User Interface

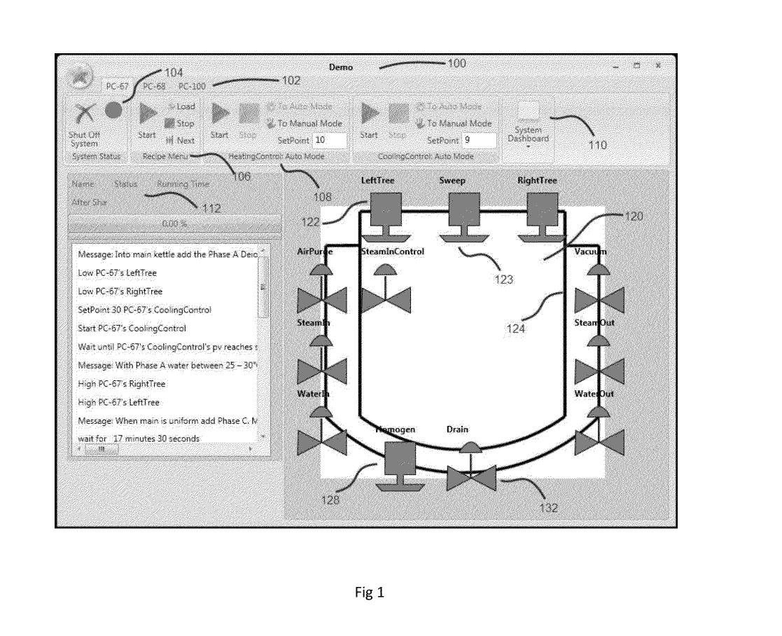

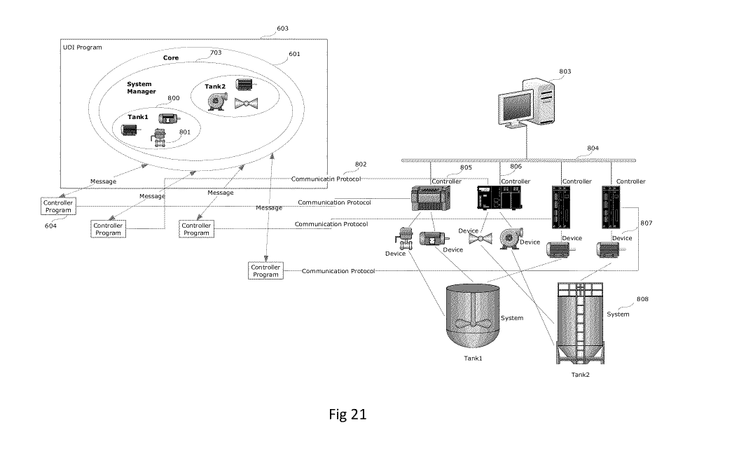

After the software is started on a computer (FIG. 21), the user will see the screen 100 shown in FIG. 1. This section will describe one embodiment of what a user/operator will see when running the inventions. The screen is divided into three principal sections: an operating section for loading and running recipes; a graphic section suitable for initiating or terminating a task and for observing the status; and a recipe section for reading the recipe instructions in simple text. Optionally, a fourth section or more may be desirable for outputting status information such as a dashboard using gauges and graphical representations.

Since a single computer may control multiple process tanks, Screen 100 includes a top bar 102 for displaying a list of systems or process tanks being controlled. In this case names PC-67, PC-68, PC-100 refer to Process Control units 67, 68 and 100. These tanks may not be contiguous with one another, though it is generally preferable for the operating PC to be in the vicinity of a tank being controlled. The particular system is selected by overlaying the mouse and clicking. A system status box 104 displays the status of the system being monitored or programmed. A recipe control box 106 can be used to load a recipe for a particular process to be performed in the processing tank, as represented by tank 120. Indeed, the situation depicted in FIG. 1 may well be considered to be the starting point of an automated procedure. The status bar shows 0% has been completed, but the Recipe has been loaded and the system is ready to commence running an automated process. At this point, nothing more is needed of the user/operator.

The process according to this recipe can be started, stopped, or a next recipe loaded by the various controls in control box 106. A heating control box 108 allows the tank represented by 120 and its contents to be heated by an appropriate heater (not shown). Heating may be started, stopped, the temperature set, and control may be changed between an automatic mode and a manual mode. A system dashboard 110, allows monitoring of various system parameters, as described below. An overall process monitor section 112 displays process or recipe name, status, running time and percentage of completion.

The representation of the tank 120 and its associated system controls include icons for four variable frequency drives (the two Tree units having only states of off, low or high), and eight valves. This suite of devices is a representation of the automated controls at unit PC-67. In general, every process tank will have its own unique set of devices and the representation shown on the screen will reflect the particular devices associated with the tank.

The variable frequency drives include those for a sweep 123 for sweeping material from the tank wall 124, and a mixer 128 for homogenizing the material being processed in the tank. A sweep 123 typically includes a member in contact with the tank wall and disposed parallel to the longitudinal axis of the tank for scraping material off the tank wall. Variable frequency drives may also be used to control motors for driving devices such as agitator baskets, propellers, or tree structures, or any other device that mixes the contents of the tank.

A tank drain valve 132 controls draining of tank 120 for purposes of cleaning or removing finished material at the end of a process in accordance with a recipe. The additional valves, including SteamIn and SteamOut, WaterIn and WaterOut and Vacuum and Purge are used for thermal regulation insider the tank jacket.

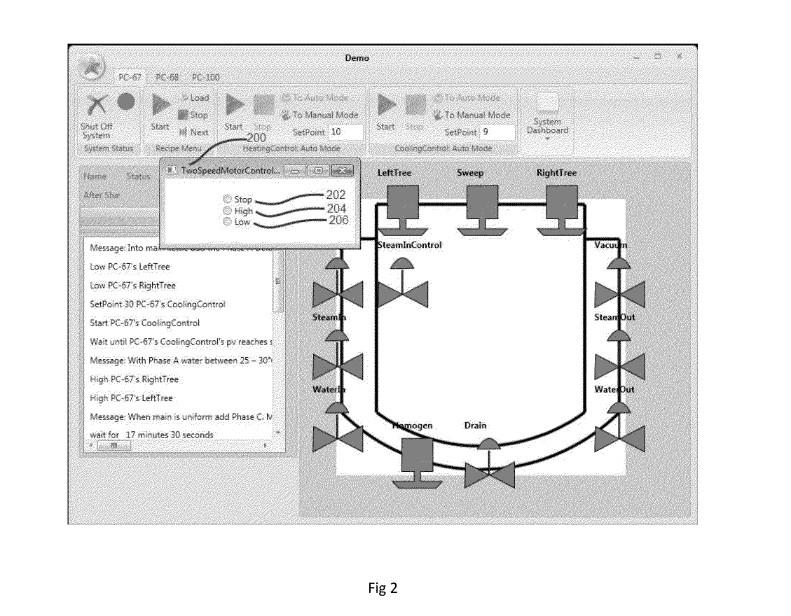

FIGS. 2 to 4, while shown in the run-time mode of operation will additionally demonstrate the ease of recipe creation since the user/operator can create and issue an instruction by simple mouse clicks. For example, referring to FIG. 2, when the mouse controlled cursor is placed over the icon for the left tree input 122, a dialog box 200 opens, allowing the user to select stop, low speed or high speed for a motor controlling injection of material (steam, air or water) into tank 120. Thus, the user is constrained to operate the device in within the restrictions of its capacity, restrictions unnecessary for the user to have known in advance.

There is an additional feature that is apparent in FIG. 2; the line of text “Low PC-67's LeftTree”. This text originated from using an interface similar to the one shown in FIG. 2, but intended as the recipe creator or recipe editor module. To create this step in a recipe, the user need only click the LeftTree icon and respond to the popup by selecting the Low radio button. The user is then able to proceed to the next step of the recipe in like manner: select a function and click.

During operation in manual mode if any option other than off is selected with the appropriate radio button 202, 204 or 206, the icon for left tree input 122 will change color; for example turn from red to green. When the recipe is run and the state of the device such as the LeftTree changes from off to on, the corresponding icon changes color from red to green.

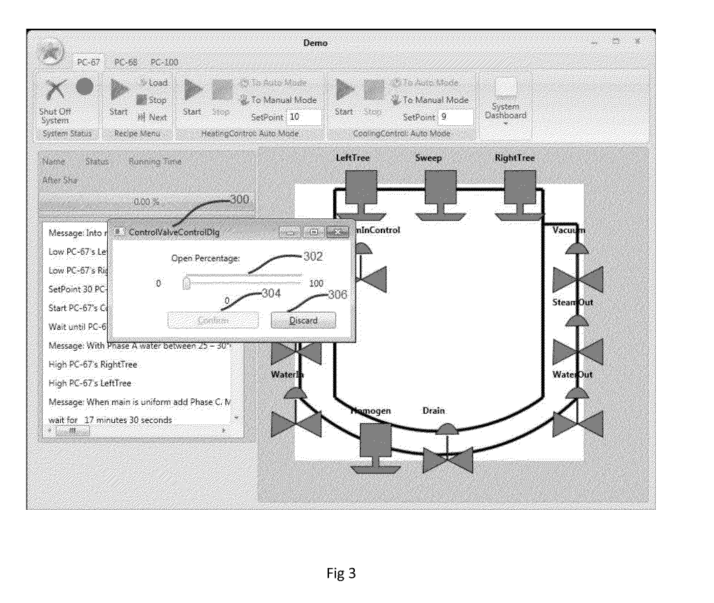

More complex decision-making is possible, beyond that of two speed motors as shown in FIG. 3. When the mouse controlled cursor is placed over any one of the valves, and the control button on the mouse is clicked, a valve control dialog box 300 is opened, and provides a mouse controlled slider 302 which is used to control the percentage to which the selected valve is opened. Any new setting is confirmed with a mouse click on confirm button 304, or discarded with a mouse click on discard button 306. A portion of the valve may be changed in color to reflect the degree to which the valve has been opened (for example, the greater the percentage of opening, the larger the change from red to green, or from green to red when the valve is closed).

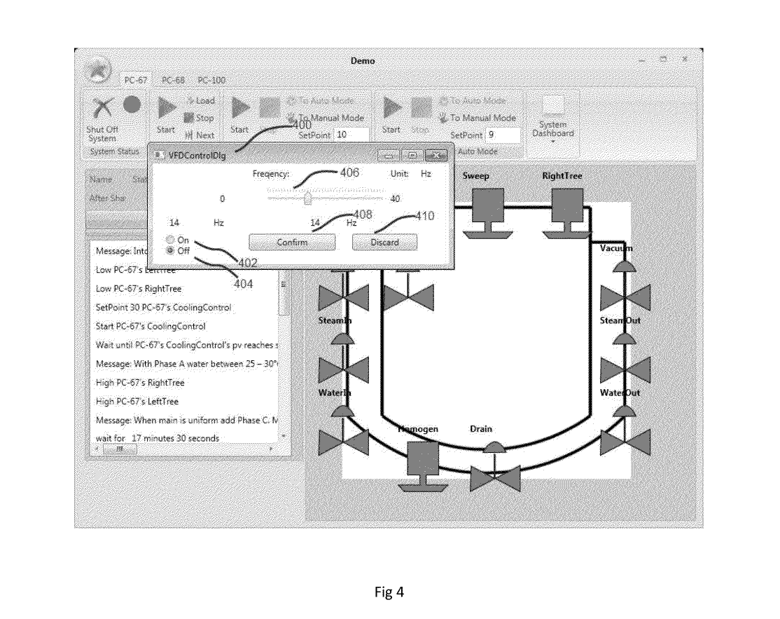

Referring to FIG. 4, when an AC motor such as a sweep for sweeping material from the tank wall 124, or a mixer 128 for homogenizing the material being processed in the tank are to be used, a variable frequency drive control dialog box 400 is opened. Radio buttons 402 and 404 are used to select whether the drive is on or off, respectively. A slider 406 is used to determine the rotational frequency of the motor. Confirm button 408 and discard button 410 can be clicked on to confirm or discard a new setting, as discussed above.

While not specifically illustrated herein, it will be understood that, where necessary, DC motors may be controlled with a similar dialog box, but the details of what is being controlled will vary due to the markedly different nature of the motor.

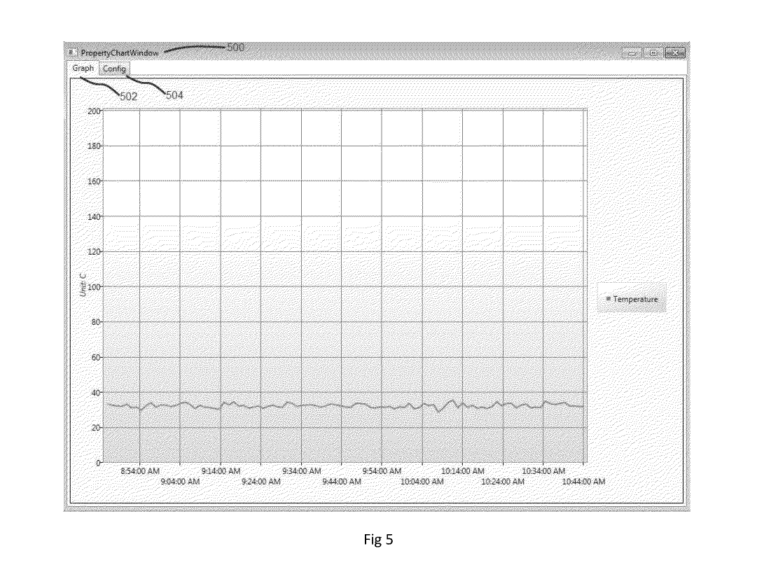

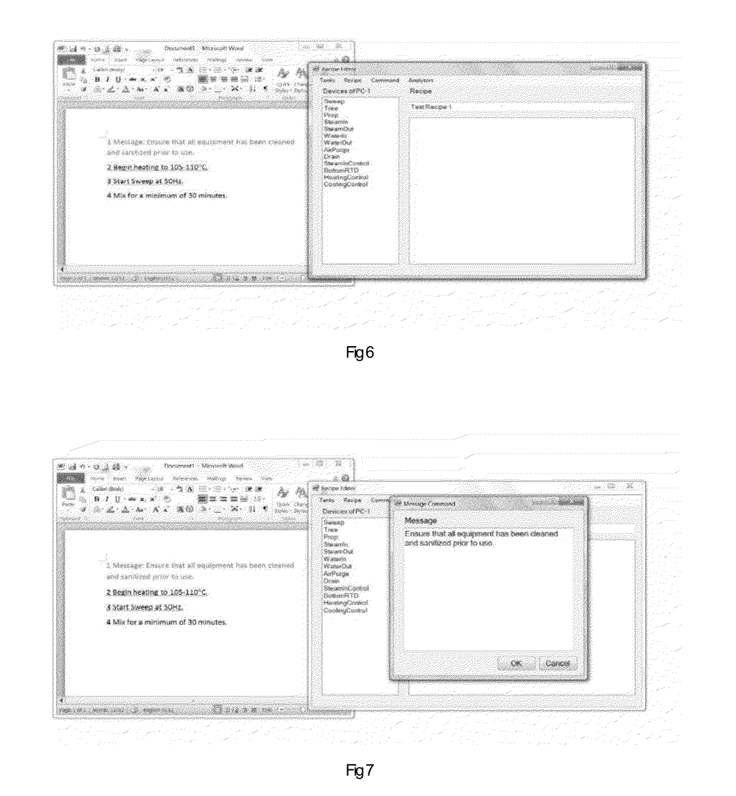

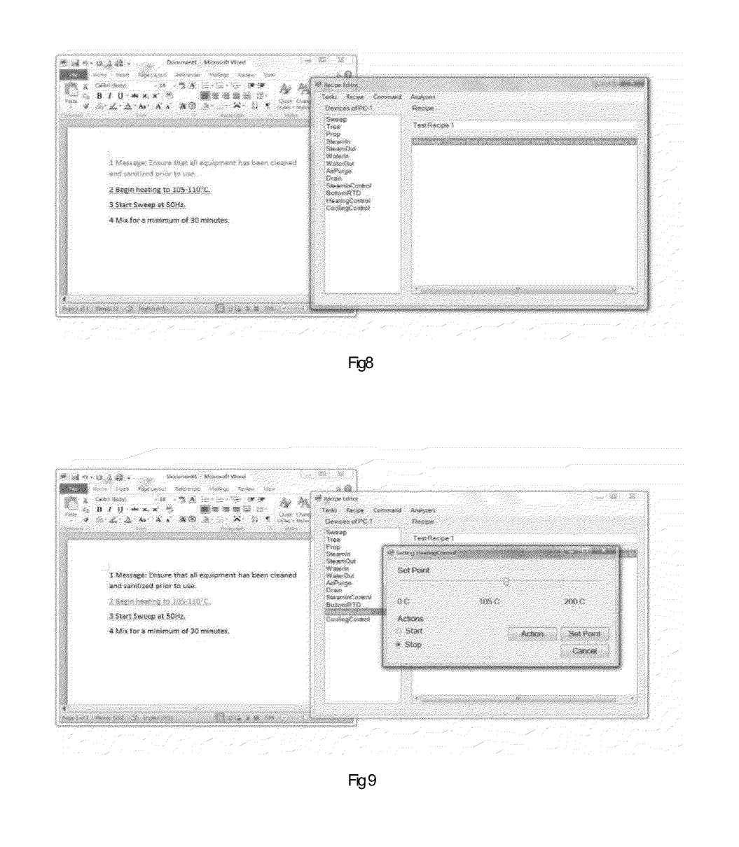

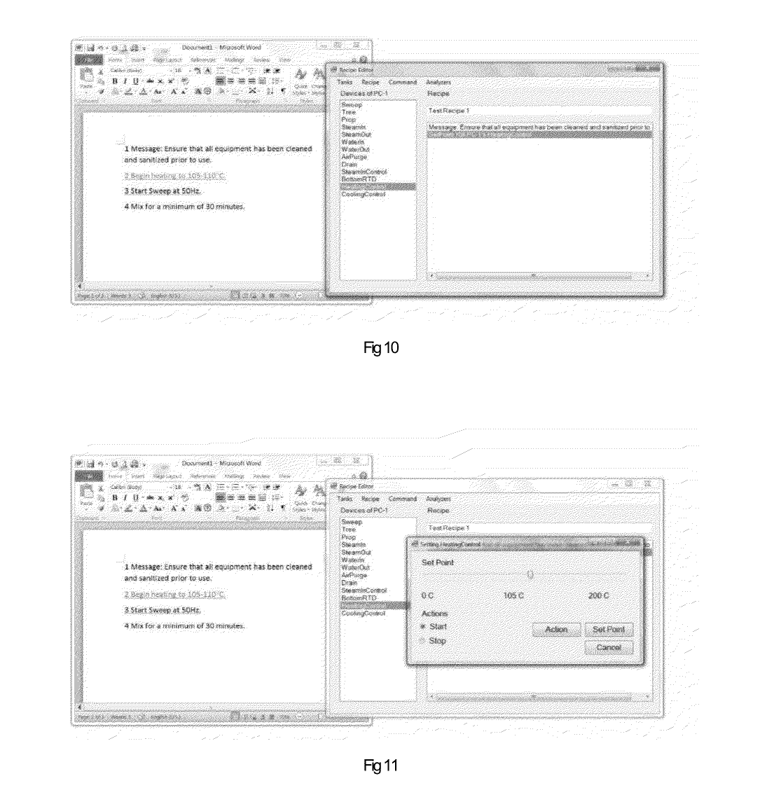

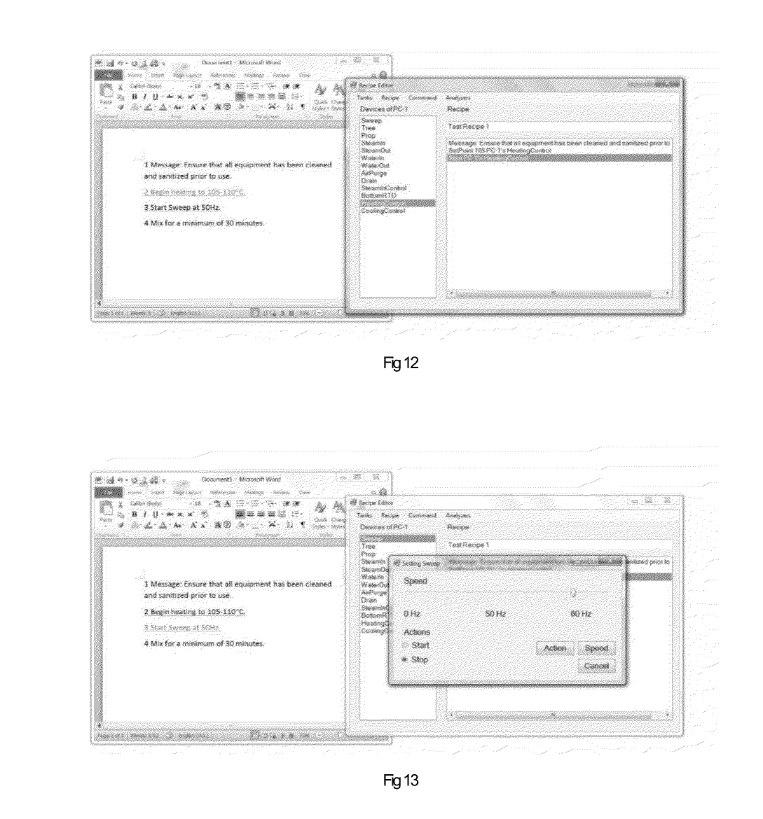

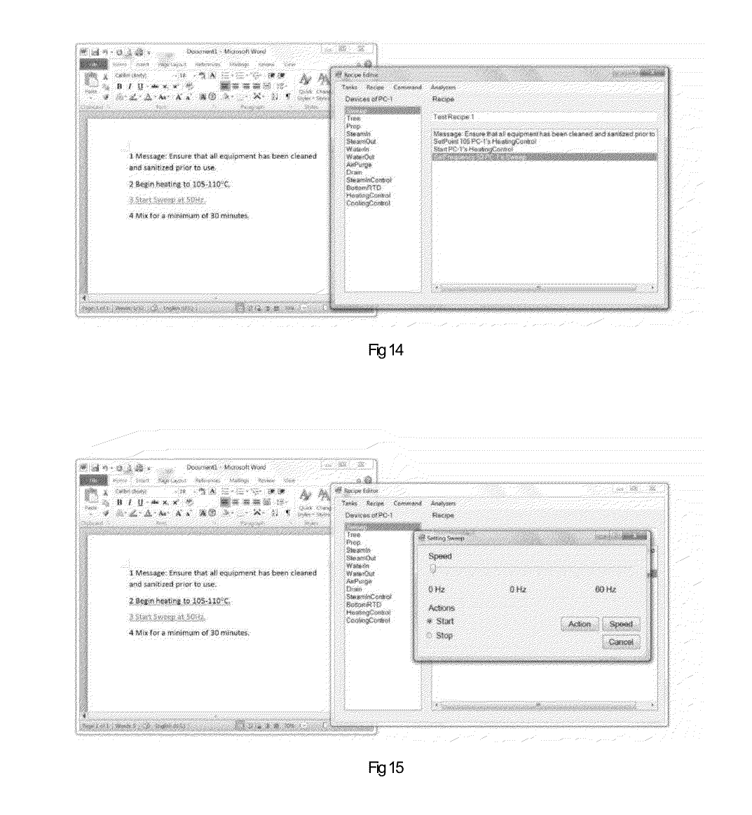

Referring to FIG. 5, clicking on a parameter represented in dashboard 110 will open a property chart window 500, which, when the graph tab 502 is selected, provides a graph of that parameter as a function of time throughout the process time that has elapsed. The configuration tab 504 provides a user interface for modifying the time scale over which data is displayed.

### 1.3 Recipe Creation

It will be understood that the portion of the system interfaced as in FIGS. 1 to 5 above does not in itself generate a recipe. However, it is convenient to use this strategy of clicking icons and receiving popups as the basis of a Recipe Creation module. Thus, while the prior discussion concentrated on the appearance of a runtime interface, the basic principles of recipe creation were included in the discussion. Of course, the recipe may also be generated using a simple text editor, of a type well know in the art, bypassing any need to create a schematic with live icon. The actual commands that are available, and their parameters, as used by the text editor, are listed below.

### 1. Device Operation.

### Parameters: System, Device, Operation, Value Command

The Command is to run an operation with a value on a system's device. For example, to open PC-1's Steam In, system=PC-1, device=Steam In, operation=Open, value=null. Another example, to set PC-1's Sweep's frequency to 100, system=PC-1, device=Sweep, operation=SetFrequency, value=100

2. Time Span Command, to Wait Some Period, when it Starts Executing.

Parameters: days, hours, minutes, seconds, such as 5 days, 6 hours, 3 minutes, 1 second

### 3. Wait for Set Point Command, Wait for a Specific Dynamic Controller to Reach its Set Point.

Parameters: system, dynamic controller, PC-1's HeatingControl

### 4. Message Command, Show User Some Message by a Pop Up Window.

Parameter: message, “Hello World”

The system described above offers many opportunities for significant savings of energy by monitoring energy being used during every step of an industrial process, and optimization of the process. For example, the viscosity of a material in the process tank may be accurately inferred from the amount of power needed to drive a mixing motor. Monitoring of the drive voltage and current being drawn is one approach to making this measurement. As an alternative, motor shaft torque may be measured by any of several well-known techniques, and equated to power being expended. The power being supplied to a heater to heat the tank, or to a storage vessel for raw materials to heat those materials prior to their being introduced into the tank, may also be monitored. For example, this could be anything from a slow ramp of temperature versus a fast ramp; to a “process at 62° C. for 10 minutes rather than 60° C. for 15 minutes” (assuming similar product quality). Another aspect of a process that may be monitored is the issue of mechanical repeatability or reliability. For example, with the use of an active database that intelligently records these parameters, and data logging, a particular step is monitored, and a determination may be made as to whether it take more or less power than it did during previous runs. In general, most of the energy usage is read by meters based on electrical use; but hot water, compressed air, etc. energy demands can be calculated based on flow rates, temperatures etc. The amount of power used may be integrated over time to determine total energy expended for a step in the process, or for a portion of a step in the process over a time period smaller than the total time needed to perform that step.

Thus, instantaneous values of parameters related to energy consumption my be displayed on the dashboard 110, as described above, and as a function of time, as described with respect to FIG. 5, and in particular with respect to a property chart window 500.

### 1.4 Versatility of the UDI Program Method

To better appreciate the simplicity of the application, FIGS. 6-18 develop a simple procedure suitable for chemical process manufacturing to show the ease with which a user may program an automation system.

FIG. 6 shows a four line procedure on the left. The steps specify a message; heating; sweeping; and mixing. When done manually, these instructions are clear to the worker. The intent in the figures is to demonstrate, step-by-step, a means of adapting the procedure to the UDI program.

On the right hand side is a list of devices in PC-1, a particular system. These devices are depicted by name, written as text, in this embodiment. But it should be understood that alternative representations are also intended. One such embodiment would use iconic-images listed in a sequence much as the text is in FIG. 6. Another embodiment would be the use of the schematic diagram as shown in FIG. 1. Above the device names listed in the figure are a series of tabs that specify selection of a tank; a recipe; a command; and an analyzer. The large white space below is the recipe field, where the user's actual instruction set are created.

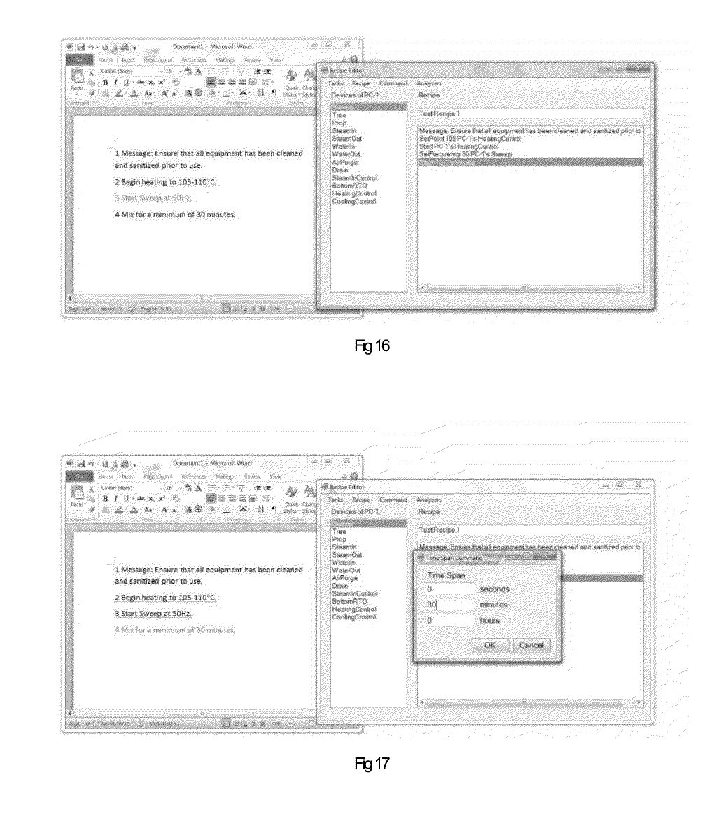

Moving from FIG. 6 to FIG. 7 requires clicking the Command tab, which introduces a message screen on which the user copies the required message. By FIG. 8, the message has now entered onto the recipe field. Also, the user, seeing that the next text instruction specifies heating, has highlighted the Heating Control text by double clicking it in the device list. FIG. 9 shows another popup; this one requesting the temperature set point, which is adjusted by a slider. The Stop radio-button is also selected under Actions, since the heater is not meant to be engaged yet, and as FIG. 10 shows, the heating control set point is established in the recipe. As shown in FIG. 11, a second double click of the Heating Control device generates a second appearance of the popup, and this time an action of START is specified. As FIG. 12 shows, the heating process required a two-step set of instructions; one for set point, one for initiation. Of course, this is a program that is under creation so the heater is not yet started, nor has the set point gone into effect. These results await execution of the program. A separate, manual mode operation scheme, for immediate actions is also available with the UDI Program.

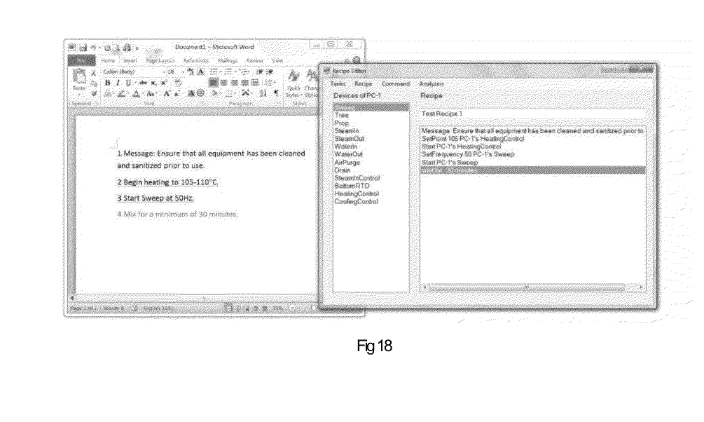

FIG. 13-16 exhibit the same two-step set-and-act structure for enabling the sweep 123 in the PC-1 tank. In FIG. 17 the duration of sweep mixing is set by double clicking on sweep 123 for a third time. The entry is shown in the recipe field in FIG. 18.

The choice of which items to include and their set points; the choice of the sequence of use; the duration; in fact of any part of the batch procedure is well within the ability of a typical user to grasp intuitively, quickly and enduringly. Hence, the UDI Program method is shown to be capable of enabling even those untrained in the art of automation programming to be usable virtually at once.

### 2.0 The Architecture of the Invention.

To most precisely grasp the scope of the invention, key words are defined as follows:
1. Controller. A controller is an electrical part that connects directly to standard manufactured modules on one side and to a computer on the other side. Examples of standard manufactured modules are valves, motors and temperature sensors. Connection to the computer may be achieved in many ways standard in the art including a serial cable or Ethernet® cable, or wireless using the appropriate protocols. A controller can pass the value of a device to a computer, this value being, for example, the analog or digital reading of a sensor. In turn the controller can send a command from a computer to the device, such as to open a valve. Examples of classes of typical controllers are an Allen-Bradley PLC, an Automation Direct Field I/O or a data acquisition board.
2. Port. A port is the basic unit on a controller, representing one specific electrical signal such as 5 VDC, 4-20 mA, etc. Ports are categorized by various parameters. Among these parameters are input or output; AC or DC voltage; voltage or current; etc. Sometimes one device, defined below, needs more than one port to implement control and feedback, or multiple functions.
3. Device. A device can be elementary and consist of what those practiced in the art consider a fundamental module or functional unit. Such an elementary device is a valve, a motor, an RTD, etc. A device can also be compound, making it a functional unit containing groups of elementary devices. An example of a compound device is a heating controller that regulates temperature by operating several valves.
4. System. A system comprises the smallest unit of production or manufacture. It generally contains several devices, but it also has its own unique functions such as turning on and shutting off. In chemical manufacturing the automation process is usually run on one system, which is sometimes a tank or kettle.
5. Analyzer. An analyzer is a measuring device that is used to characterize physical or chemical attributes of the material being manufactured. Analyzers may be real, i.e. actual electronic packages designed for a measurement application such as an optical analyzer to measure the color of the material. Alternatively, analyzers may be virtual, i.e. comprised of opportunistic data that is obtainable from equipment in the system which when suitably analyzed may also provide physical or chemical attributes of the material being manufactured. An example is a variable frequency drive, which controls motor speed and therefore the rotation of shafts in a tank. When the power consumed to rotate the shaft is suitably considered, a measurement of the material resistance, the viscosity, can be calculated. Finally, compound analyzers, which as will be seen below, are compact lab automation devices capable of not only making measurements, but also preparing samples by dilution or other needs-specific steps, can be used to make more elaborate analytical measurements of physical or chemical attributes.

### 2.1 Software Architecture

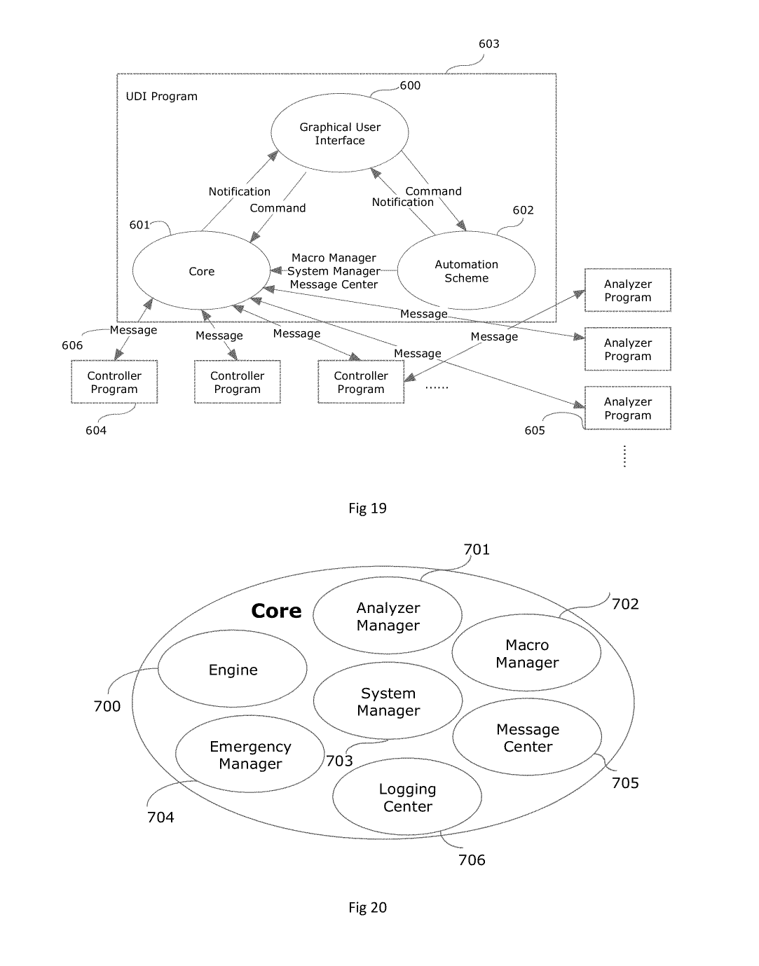

FIG. 19 shows the software architecture of the UDI program 603, comprising a Core 601, an Automation Scheme 602 and a Graphical User Interface 600 (described above). The Core 601 makes the UDI Program run; Graphical User Interface 600 expresses the program 603 to users and provides operation for users to operate the program 603. A simple way of understanding this is to consider the Graphical User Interface to be the way information passes to the program and to the user; the Automation Scheme is the list of activities that are to be automated; and the Core executes this list of activities. As FIGS. 1-5 have shown, the information in the Automation Scheme, the recipe in those examples, can be readily arranged in the sequence desired by the user.

When the information in either the Core 601 or Automation Scheme 602 changes, push notifications are pushed to the Graphical User Interface 600 to update the information on the interface. In other words, something such as a change in the temperature reading or the progression to the next line in the recipe is seen on the Graphical User Interface. Symmetrically, operations initiated by the user on the Graphical User Interface can pass to the Core 601 and Automation Scheme 602 as commands to execute.

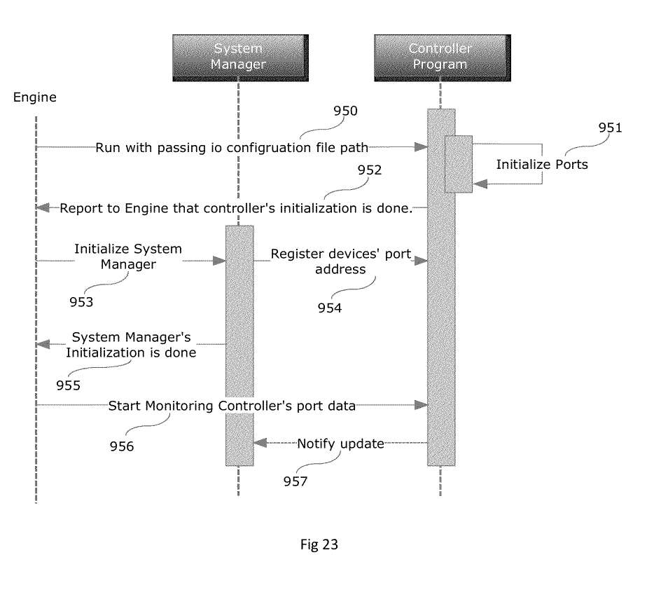

The UDI Program 603 communicates with Controller Programs 604 by messages 606 using message queue, an operating system level service. In turn the Controller Program 604 talks to a Controller, which as described above can be a PLC or a Field I/O. The program 603 also sends command messages 606 to operate devices or inquire value of devices via a Controller Program 604. Additionally, Controller Programs 604 send notification messages 606 957 (FIG. 23) to the UDI Program 603 to notify updates of value of devices. The UDI Program 603 may communicate with multiple Controller Programs 604 simultaneously when needed. In other words, the UDI Program may, for example, communicate with multiple PLCs.

The program 603 can communicate with different kinds of Analyzer Programs 605 to implement analyzing functions. The program 603 sends command message 606 to analyzer programs 605 to analyze the product and analyzer programs 605 send messages 606 back to the program 603 reporting the analyzing result or the action after analysis. Communication with real analyzers is show by the arrows between the Core 601 and the Analyzer Program 605. These can indicate, for example that the Core 601, having been told by the Automation Scheme to turn on the analyzer does so. An interesting application occurs when the analyzer, sensing that a part of the process is complete, reports this information to the Core 601, which in turn can direct the Controller Program 604 to modify a procedure or to advance to the next step.

It is emphasized that the identification of the Automation Scheme with the recipe in a batch chemical manufacturing procedure is but one embodiment of the general invention. Another is the use in Laboratory Automation, wherein a protocol for making, for example a series of dilutions on sample materials and then performing measurements is made possible with a similarly flexible approach of selecting instructions in whatever order is needed.

### 2.2 Structure of the Core

Referring to FIG. 20, the Core is the major action-taking module of the Universal DART Interface, 603. The Core has seven parts. These will be described briefly. The Engine 700 is responsible for running controller programs, thereby giving it the responsibility to interact with devices such as valves and motors. The Analyzer Manager 701 is responsible for communicating with different kinds of analyzer programs including those that are real, such as optical analyzers, and those that are virtual, such as when a viscosity is derived from power usage in a VFD turning a shaft or shafts in a tank. The Macro Manager 702 is responsible for managing macros, which are a small user-customized script to run a series of commands. An example of the use and convenience of a macro is readily understood with reference to changing the thermal conditions in tank, as when the requirement is to change from cooling to heating. In such a circumstance a series of steps may need to be initiated according to a strict sequence. These include shutting the valve that has allowed passage of cooling water to the vessel; opening a second valve to release cooling water resident in the tank jacket to the drain; opening a steam valve, etc. The System Manager 703 is responsible for managing all systems and devices that the program 603 controls. It enables actions such as ensuring a recipe uses the correct devices in a system. A recipe calls the System Manager to find the system it runs on and to check that devices are actually in that system. The Emergency Manager 704 manages all known and defined emergencies. This knowledge is stored as a user-defined table of conditions. When a matching condition to a table entry is found, a sequence predetermined by that entry is automatically initiated. The Message Center 705 is responsible for communication with analyzer programs and controller programs. The messages can range widely and may include items such as “Add 10 kilograms of compound and hit START” or “The analyzer says the batch is ready and the system will shut down in three minutes.” All parts of the program 603 need to call the message center 705 to send messages or receive messages. The Logging Center 706 is responsible for recording data for additional processing. Information can be stored in a local database or in the cloud using, for example, Microsoft SQL, for future review and analysis. When the program 603 is running, the Logging Center 706 keeps recording and updating the device data. A user can watch the data in a period and draw them into charts. One application of this capability is comparison profiling. For example, suppose that a chemical processing system was monitoring its energy consumption using the Logging Center. The current application could be compared with stored results of similar runs at the same stage of production to determine if there are unexpected energy-consumption variations. An increase in the current application could be an indication of faulty equipment operating with reduced efficiency; a decrease could be an indication of a prior fault. Furthermore, deliberate variation schemes may be studied and compared for optimum energy utilization. In one instance, for example, a process temperature may be ramped quickly and held at the target temperature; in another, the ramp may be slower and the hold time may be extended. These two temperature verses time profiles can be logged and the data processed to objectively compare the effect of these profiles on both product quality and energy consumption.

### 2.3 Link Between Hardware and Software

FIG. 21 demonstrates the relationship between the UDI Program 603, especially the Core 601, and the implementation of industrial automation. This case uses chemical manufacture as an example, but others are possible. The hardware includes a computer 803, several controllers 805 and devices 807 which are shown installed to tanks as part of a system 808. The UDI Program 603 and Controller Programs 604 are installed in the computer 803. A Controller Program 604 can, for example, find a controller 805 through Ethernet switch 804 by using the controller's address. The Controller Program 604 can communicate to the controller 805 using communication protocols 802 that depend on the controller type and configuration. For example, when the Controller Program 604 controls an Allen-Bradley PLC 805 and when this PLC uses a serial cable to connect to the computer, ABDF1 protocol is employed. Alternatively, when the PLC uses Ethernet cable connections to the computer, the Controller Program 604 uses Ethernet/IP protocol to communicate.

The System Manager 703 stores all necessary information such as details of the devices and where they are connected in the controller hardware of individual systems 800 which correspond to the real system 808. Each system 800 contains a device list containing devices 801 which corresponding to the real device 807. While it might appear that the number of controllers should equal the number of systems, this is not generally necessary. A system can use multiple controllers to control devices; or one controller may operate multiple systems.

### 2.4 Details of the Process

A Process means a program that is running on a computer. Upon start of the execution of the UDI Program 603, the process needs to initialize itself from configuration files that are typically stored locally, for example on the hard disk. This requirement for initialization from stored files is a consequence of the flexibility of the UDI Program 603. System components are customized by users in, for example the chemical manufacturing industry, to address numerous variations such as number and types of valves or motors, a variability that must be represented and expressed concretely in the UDI Program 603. In fact, variability resides not only in the components but also in the graphical layout, which is a user adjustable feature of the way the system is represented.

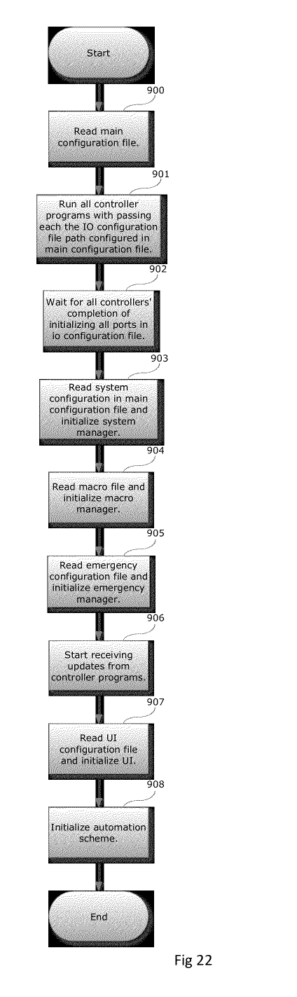

FIG. 22 provides a flow chart for initialization of the program 603. Since there are several types of configuration files associated with the program 603, these must all be readily accessible, as for example, files stored under or in a my document folder. The first step is to read main configuration file 900, a file with two distinct parts. The first part of the main configuration file lists all controllers the system is using. Each of these controllers has associated with it an execution file, and this first part lists its respective file name and file location. Also listed are the associated 10 configuration file name and location of the particular controller. This controller list in the main configuration file enables the smooth execution of all controller programs 901. The second part of the main configuration file contains a second list. This second list is of systems. The entries in the list include the name of each system and an accompanying list of system's devices, each of which includes device name, device type, such as analog valve, VFD, and variable lists.

Returning to the controllers, each of these must be initialized in an orderly and comprehensive way, meaning that for each controller, all data must be ready for use at initialization so that the UDI Program 603 can then run properly with all variables properly accounted for. There is back and forth communication between the program 603 and controller programs 604 to make sure they are initializing in a correct order.

This activity, shown in 902, is explained further in FIG. 23. The program 603, specifically the Engine 700, initiates the controller execution file; the Engine 700 also passes to the controller the parameters of the 10 configuration file name and location 950. Equipped with these parameters by the Engine 700, the controller program starts by finding the 10 configuration file and reading it into memory. An 10 configuration file includes the name of the controller, communication protocol type, such as RS485, AB-DF1, connection type and parameters, such as RS232 or Ethernet. The IO configuration file also includes the port table; the list of ports on the controller. Each entry of the port table contains both the port name, which is used in all relevant parts of the program 603 and analyzer programs 605 as well as the port address, the real address of the port used by communication protocols to communicate with devices. Given this information, the controller program 604 can then read all values from each port specified by the port table; it gets the initial value of each port 951. If the port is write-only such as the analog output on electronic boards that permit writing to them but for which their value cannot be obtained, the controller program 604 will use the newest value in the local database to initialize it. In other words, the value will be obtained from what had been most recently stored on the database in the local drive. Subsequently, the controller program 604 sends a message back to the UDI Program 603 confirming initialization 952.

After the main program 603 receives all initialization-done messages from each controller program 604 at 902, at 903, it uses the second part of the main configuration file to initialize the System Manager 703 at 953 (FIG. 23). The variables are parameters associated with ports. For example, one type of port, a digital valve, has only the state variable, 0 or 1, corresponding to an open or shut state; but another port, a VFD might have many parameters including reference frequency, output frequency, operation status and operation command. Depending upon application, a variable might be associated with just one port on a controller; alternatively it may also correspond to multiple ports on multiple controllers. Consider, for example, a case involving motor speed, where only three conditions are possible: off, on and error. The motor connection to the controller requires two signals, each of which may be either 0 or 1. When both are 0, the motor stops; when one is 1 and the other 0, the motor runs; and when both are 1, there is an error condition. For the UDI Program 603 to turn the motor on, it must send two messages, one to each port; a 1 and a 0 need to be sent.

The initialization of the system manager at 903 means that the variables (the parameters associated with ports), as described above, are read into memory. During initialization at 903 the program 603 sends a registration message to controller programs 604 to subscribe to the update notification from the controller programs at 954 (FIG. 23). This means, in effect, that the port will be alert to update values; without registration/subscription the port is dormant. Suitably registered, the port provides newest value to the controller programs 604; the ports refresh. For ports that have subscribers, the controller program 604 will send out update information 957 (FIG. 23) to those subscribers whenever the port value changes. If there is no subscriber, no notification message is sent out.

Once the system manager completes initialization, the other managers also initialize one by one. The Macro Manager 702 uses its own configuration file to initialize at 904. The Macro Manager configuration file contains all user pre-defined macros, which can help the user do a series of actions in one command. For example, some tanks need to be drained of water before they are heated. The drain algorithm might be: open drain valve for 5 seconds then open air purge for 2 minutes then close both of them. The macro takes the above actions and then starts the heating action together as one command to execute, which makes for user convenience. The Emergency Manager initializes at 805 with its own configuration file, storing it into memory. The Emergency Manager configuration file contains all user pre-defined emergency conditions and the corresponding required responses. An example of an emergency condition/response if/then statement is “IF steam in valve AND water in valve are open at the same time, THEN close all steam and water valves”.

When all configuration files have been read into memory, all information is stored in the Core 601. Then the program 603 sends message to all controller programs saying they can begin to refresh their port tables to renew the value of all ports continuously at 906, 956 (FIG. 23).

After the Core 601 is finished reading all the configuration files, the graphical user interface reads UI configuration files to make a cartoon of the system schematic. This graphic contains a visual expression of the system, including the size and location of each device 907.

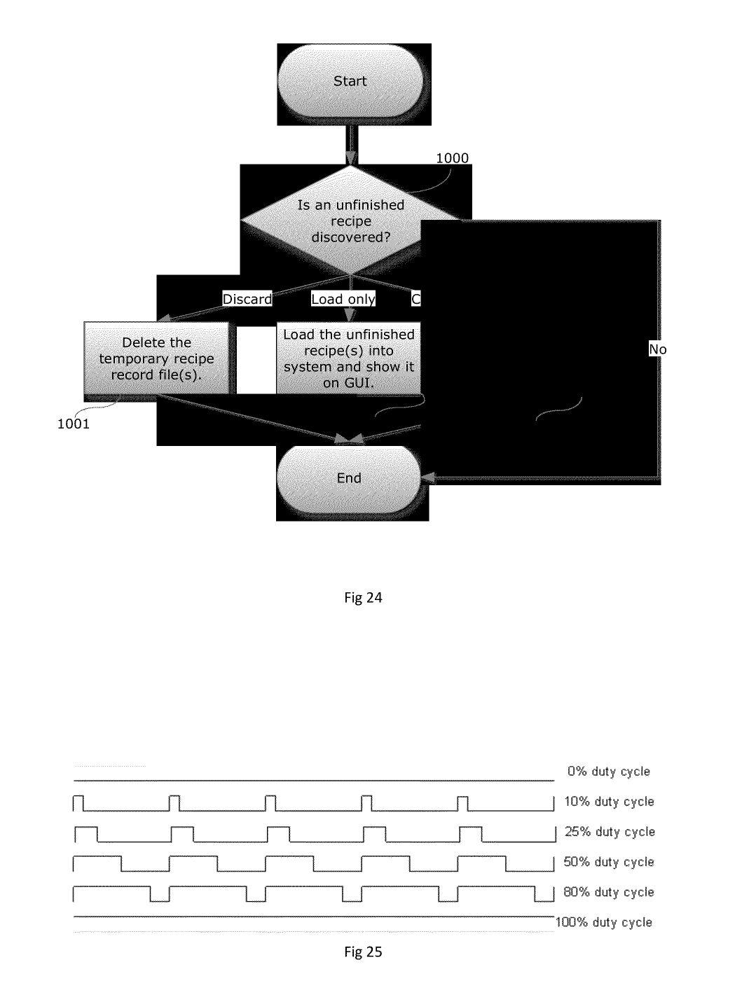

The last step is to initialize the automation scheme at 908, which may in one instance be a chemical batch manufacturing function and in another a laboratory automation procedure. These are different schemes in the sense that they are totally distinct activities. Necessarily different automation schemes will have their own initialization, possessing specialized hardware and functionality. FIG. 24 demonstrates the initialization of recipe system, a particular automation scheme. During a recipe's run, the recipe system logs the record of such items as current step, running time, etc. to the temporary file on hard disk. At the conclusion, the temporary file can be purged when a more thoroughly formatted final report is generated.

If a disruption such as a power failure occurs during a recipe run, the recipe is halted, but the temporary data storage file remains on the hard disk. Thus, the first step of recipe system's initialization is a search for temporary files or unfinished recipes at 1000. If none are found, the initialization is complete. However, if at least one is found, it will prompt the user for to decide on a course of action: discard at 1001, meaning delete the temporary files and ignore the last unfinished recipes; load unfinished recipes at 1002, into system and show them on the screen without further action; or after loading recipes, continue the recipe run from the step recorded as the current step in the temporary file.

### 2.5 Universality of the UDI Program Architecture

Conceptually, the program can be considered to divide into two parts, the first being the user interface and the second the inner workings that enable the intended actions. Both of these parts enjoy a measure of generality, as follows. To understand this readily, begin from the affected end, for example a steam valve. This device is addressed by a controller, which can be a PLC of specific manufacture. Perhaps the steam valve is connected to the address N10:4/3 on the PLC. In routine operation, the PLC would have a configuration file that links this channel to the steam valve. In the UDI Program, identification of this location is associated with a given name such as PC-1_SteamIn_Switch so that this name and the channel are linked. Additionally, a controller is identified in the UDI Program with a specified name such as ABDF1RS232. Since the PC-1_SteamIn_Switch is identified with a physical location this name is the tag that the UDI Program has (the mapping) to the channel on the controller.

What is needed then is the communication protocol for the controller, the method that the controller uses to access this channel. That is a key part of the controller program. The generality of the UDI Program depends on using the precise communication protocol for the specific controller. In the example, a PLC was used. But there are numerous different manufacturers and models; also there are numerous alternative controllers. However, the strategy of linking a physical address with a variable name and then passing an instruction to a specific channel is the same.

The User Interface is also generalizable, but in this case it is according to language. Consider how the UI connects to the execution layer, how it maps an icon to a physical location on a controller. This is done by linking the name, for example PC-1_SteamIn_Switch to a user assigned name. While logically, the user would typically select a name with the word steam, there might be reasons to do otherwise, as when the user refers to steam in a different language. The designation then can be to a dummy variable, say D1, which is a placeholder for the string that is shown on the user interface. Here it is meant to point to the first entry in a row 1 of a list of UI text variables. Similarly, a second icon, linked to another channel would be D2, and so on. In fact, all of columnl are in the same language. A user may then create a matrix, adding other languages or symbols. Logically, then column 2 would be a parallel set of names, but in a different language. This method is employable for as many languages as desired. At the time that the actual text is used, the only needed specification to determine which language is selected is the column number. In this system a simple click on the keyboard, ALT F #, enables instant change of language.

### 3.0 Applying the Concepts

To show the wide-ranging applicability of the UDI concept, four different computational devices, or “engines”, are selected as examples and shown in Table 1. These four are a microcontroller, a PLC, a data acquisition board (DAQ) and a Field I/O. In particular, an Arduino, an open-source platform (http://www.arduino.cc/) was used to represent the microcontroller; an Allen-Bradley model 1500, the PLC; an Ontrak control board, e.g. the ADR 2100, (Ontrak Control Systems Inc, Sudbury, Ontario, Canada), for the DAQ; and an Applied Automation XXX (Bridgend, UK) for the Field I/O. These are selected examples and should not be considered limitations of the invention.

The manner of illustration is by the selection of four types of i/o commonly used in automation: digital input and digital output; analog read and analog write. The specific elements chosen are illustrated in Table 1.

Each of the engines will be illustrated to operate all four i/o devices. To do so, three actions must be addressed: physical connection; software connection; and mapping.

The subsequent sections provide the detailed explanation for multiple embodiments of the invention.

What is common to all of these engines is the GUI that a user may choose at the PC. For many practical applications the specific engine chosen will be transparent to the user, meaning that from an operational viewpoint (from the perspective of actually doing the automation), the user may be unaware of which engine had been selected. This versatility has multiple advantages.

First of all, when selecting the components for a DART, a prospective user may take advantage of cost and size. Thus, as will be shown later in this specification, laboratory-scale automation may be affected using low-cost micro-controllers. Alternatively, confidence or experience with one or another type of engine, for example a PLC, may prompt selection of that means of control.

Secondly, the ability to retrofit UDI technology to engines such as PLCs and Field I/O devices in the field is a very practical matter. The advantage of simplified recipe-making or other perceived value offers to prospective adopters of UDI technology the very real and practical opportunity to do field-upgrading.

In the discussion below the conceptual interchangeability of the engines is shown explicitly.

3.1 Physical Connections: this is to Describe all of the Physical Wiring Connections Between Components.
Arduino: Each type of component which is controlled by the Arduino needs some type of converter to change the 5 volt logic from the Arduino into a signal which can power or read the component. The PC connects to the Arduino through USB.
PLC: Not all types of components which are controlled by the PLC need some type of converter to be able to interface with the PLC. Since the PLC has different types of modules, the appropriate module to interface with that component is selected. The PLC is connected on O:0/0 to the solenoid valve. On pin I:0/0 it is connected to the limit switch. On pin O:0.0 it is connected to the analog motor controller. On pin I:0.0 it is connected to the analog temperature sensor. The PLC is connected to the PC through a Serial port.
Ontrak: Each type of component which is controlled by the Ontrak board needs some type of converter to change the 5 volt logic from the Ontrak board into a signal which can power or read the component. The Ontrak board is connected on pin PA1 to the 12 volt relay. On pin PA2 it is connected to the LLC. On pin PWMA it is connected to the analog motor controller. On pin AN0 it is connected to the analog thermocouple amplifier. The PC connects to the Ontrak board through serial communication.
Field I/O: Pin Addressing protocol is unique in the Field I/O. Modules are automatically detected by the Field I/O. The pins between 0 and 9999 will all be used for digital output signals. The pins between 10000 and 19999 will all be used for digital input signals. The pins between 20000 and 29999 will all be used for analog input signals. The pins between 30000 and 39999 will all be used for analog output signals. The Field I/O is connected on pin DO,1 to the solenoid valve. On pin DI,10001 it is connected to the limit switch. On pin AO,30001 it is connected to the analog motor controller. On pin AI,20001 it is connected to the Analog thermocouple. Ethernet connection attaches the Field I/O to the computer, using Modbus protocol. The PC connects to the Field I/O through an Ethernet connection.

### 3.1.1 Digital Output

The 12V Solenoid valve requires a 12V DC voltage to operate. When it gets +12V across its terminals it opens, when it gets 0V across its terminals it is closed. The terminals of the 12V solenoid valve are connected to the output terminals of the 12V relay. When the relay 12V receives +5V across its input terminals it outputs +12V across its output terminals. When it receives 0V across its input terminals it outputs 0V across its output terminals.
Arduino: One input terminal from the 12V relay goes to an output pin on the Arduino, in this case, Pin 1. The other pin goes to digital output ground.
PLC: The 12V relay is built into the PLC. One wire of the relay goes from a digital output on the PLC in this case O:0/0, the other to the digital output common ground.
Ontrak: One input terminal from the 12V relay goes to an output pin on the Ontrak board, in this case, Pin PA1, the other to the digital output common ground.
Field I/O: The Field I/O has relay output modules. The Solenoid valve is wired to a relay output, in this case DO,1 (Digital Output, channel 1), the other to the digital output common ground.

### 3.1.2 Digital Input

The water fill level limit switch is a 12V sensor. When the water fill level is at maximum, the limit switch will trigger. When the limit switch is triggered it will output +12V across its output terminals. When the limit switch is not active it will output 0V across its output terminals.
Arduino: The output terminals are connected to the limit switch logic level converter (LLC). When +12V is put across the LLC's input terminals it will output +5V across its output terminals. When 0V is put across the LLC's input terminals it will output 0V across its output terminals. One output terminal on the LLC goes to an input pin on the Arduino, in this case, pin 2; the other terminal wires to the common ground.
PLC: The output terminals are connected to the Digital Input on the PLC in this case I:0/0, and the digital input common ground.
Ontrak: The output terminals are connected to the limit switch logic level converter (LLC). When +12V is put across the LLC's input terminals it will output +5V across its output terminals. When 0V is put across the LLC's input terminals it will output 0V across its output terminals. One output terminal on the LLC goes to an input pin on the Ontrak board, in this case, pin PA2; the other goes to the digital input common ground.
Field I/O: The Output from the limit switch is wired directly to the Field I/O digital input pins, in this case one goes to DI,10001 (Digital Input 1) the other to the digital input common ground.

### 3.1.3 Analog Read

The analog thermocouple is a passive device that generates voltage according to the temperature it senses.
Arduino: The output terminals of the thermocouple are connected to the analog thermocouple amplifier input terminals. The analog thermocouple amplifier will scale the input from the Analog thermocouple to a readable range for the Arduino. For example it will scale a 0-500 mv input signal to a 0-5V output signal. The 0-5V output signal is then output to the Arduino. The Arduino reads the analog signal through an analog read pin, in this case, pin 16. (Pin 16 is an analog input pin).
PLC: The output terminals of the thermocouple are connected to the PLC analog input in this case I:0.0, and to the analog input common ground.
Ontrak: The output terminals of the thermocouple are connected to the analog thermocouple amplifier input terminals. The analog thermocouple amplifier will scale the input from the Analog thermocouple to a readable range for the Ontrak Board. For example it will scale a 0-500 mv input signal to a 0-5V output signal. The 0-5V output signal is then input to the Ontrak Board. The Ontrak board reads the analog signal through an analog read pin, in this case, pin AN0; the other terminal is connected to the analog input common ground.
Field I/O: The output terminals of the thermocouple are connected to the Field I/O analog input pins. One terminal of the thermocouple would be wired to analog input AI,20001, the other to the analog input common ground.

### 3.1.4 Analog Write

The DC motor is a motor which supports voltages from 0-36V DC input. The speed of the motor will depend on the voltage applied to its terminals. When it receives 0V it will be stopped. When it receives 36V it will operate at maximum speed. Square waves with different duty cycles are illustrated in FIG. 25.
Arduino: The input terminals of the motor are connected to the output terminals of the 36V Analog motor controller. The Analog motor controller's input terminal is connected to an Arduino analog output pin. In this case pin 3. The analog motor controller converts the Pulse Wave Modulation (PWM) wave which specifies the duty cycle into a DC voltage between 0 and 36V depending on the duty cycle. The Arduino is connected on Pin 1 to the 12V relay. On pin 2 it is connected to the LLC. On pin 3 it is connected to the analog motor controller. On pin 16 it is connected to the Analog thermocouple amplifier. USB connection attaches the Arduino to the computer
PLC: If the motor has two wires one is signal, one is ground, then, signal connect to the signal channel of PLC. The ground connects to ground channel of PLC. The input terminals of the motor are connected to the output terminals of the 36V analog motor controller. The analog motor controller's input terminal is connected to a PLC analog output pin. In this case pin O:0.0. The analog motor controller converts the Analog current signal into an appropriate output voltage to the motor.
Ontrak: The input terminals of the motor are connected to the output terminals of the 36V analog motor controller. The analog motor controller's input terminal is connected to an Ontrak board analog output pin. In this case pin PWMA. The analog motor controller converts the Pulse Wave Modulation (PWM) wave which specifies the duty cycle into a DC voltage between 0 and 36V depending on the duty cycle.
Field I/O: The input terminals of the motor are connected to the output terminals of the 36V analog motor controller. The analog motor controller's input terminal is connected to a Field I/O analog output pin. In this case pin AO,30001. The analog motor controller converts the analog current signal which specifies the DC voltage between 0 and 36V depending on the output current from between 4-20 ma.

### 3.2 Software Connections

### 3.2.1. Arduino Software Connections

### On the Arduino:

Pin 1 is set to be a digital output pin.

Pin 2 is set to be a digital input pin.

Pin 3 is set to be a Analog output pin.

Pin 16 is set to be a Analog input pin.

Serial Communication at 9600 bps is set on the USB port.

Sample list of protocol and connection types.

The communication software on the Arduino is set up in two parts. One is to read from the pins, the other is to write from the pins. Each of those is in two parts, analog and digital. The 4 functions which are called to do these are:

### DigitalWrite(Pin#,PinState)

### DigitalRead(Pin#,OutputVariable)

### AnalogWrite(Pin#,PinState)

### AnalogRead(Pin#,OutputVariable)

List of some of the functions that can be applied to pins on the Arduino.

These 4 functions are called, depending on the serial input coming to the Arduino's USB port from the PC. The Arduino receives a message in serial, parses the message for commands, and then calls the appropriate function for each command. For example:

DW01H//will call the function DigitalWrite(1,HIGH)
DR02//will call the function DigitalRead(2)
AW03v255//will call the function AnalogWrite(3,255)
AR16//will call the function AnalogRead(16)

Sample commands sent to the Arduino. In the AnalogWrite function, the Arduino scales the voltage between 0V and 5V with 255 steps of accuracy. At 255 it is at a steady +5V.

The pin modes of each pin on the Arduino are sent via Serial communication to the Arduino as well. For example:

DO01//will set pin 1 to be a Digital Output
DI02//will set pin 2 to be a Digital Input
AO03//will set pin 3 to be an Analog Output
AI16//will set pin 16 to be an Analog Input

Sample header sent to the Arduino on boot. These are the first commands sent to the Arduino to initialize the pins in the correct state.

### 3.2.2 PLC Software Connections:

### On the PLC:

Pin O:0/0 is a digital output pin.

Pin I:0/0 a digital input pin.

Pin O:0.0 is a Analog output pin.

Pin I:0.0 is a Analog input pin.

Serial Communication at 9600 bps is set on the Serial port.

Sample list of connection types.

The communication between a computer and PLC is set by address tables. Values are written to addresses. The values written to the addresses are then transferred to the PLC using Standard Modbus Protocol.

With PLC's, the pin configuration is already settled, the pin modes do not need to be declared. The addresses that are being written to already determine the pin-mode of the address. See Table 2.

Each value for each address is written to the address within the PLC communication program. The program then updates the PLC with the values written to each address. The PC communicates with the PLC using ModBus Protocol over the Serial line. See Table 3.

The data written to the table is then continuously updated on the PLC.

### 3.2.3 Ontrak Software Connections:

On the Ontrak:

Pin PA0 is set to be a digital output.

Pin PA1 is set to be a digital input.

Pin RD0 is an analog input.

Pin PWMA is a PWM output.

Serial Communication at 9600 bps is set on the Serial Port.

Sample list of protocol and connection types.

The Ontrak board needs its pin-modes to be configured for the Digital IO. Pin-modes for Analog Input and PWM output are set by the hardware. After the controller boots up, which port is output and which port is input, must be configured.

To set and write to a digital pin as an output:

10 OPEN “COM1:9600,N,8,1,CS,DS,RS” AS#1;opens com port
20 CLS; clears screen
30 PRINT#1, “SETPA0”; sets PA0*
40 REM ;forces <cr>
50 PRINT#1, “CPA11111110”; configures PA0 as output

To set a digital Pin as an Input:

10 OPEN “COM1:9600,N,8,1,CS,DS,RS” AS#1;opens corn port
20 CLS; clears screen
30 LOCATE 1,1;locates cursor
40 PRINT#1, “CPA11111111”; configures port as input
50 REM; forces <CR>
60 PRINT#1, “RPA0”; reads PA0 (SW1)
70 INPUT#1, SW1; saves status in variable SW1

To set and read an Analog Temperature Sensor:

0 OPEN “COM1:9600,N,8,1,CS,DS,RS” AS#1; open com port
20 CLS; clear screen
30 LOCATE 1,1; locate cursor
40 PRINT#1, “RD0”; send RD0 command to ADR2100
50 INPUT#1, READING; retrieve data from ADR2100
60 TEMPERATURE=((READING/1023)*5)-2.73)*100; convert data to Celsius*
70 PRINT “Temperature is”, TEMPERATURE; display it
80 GOTO 30; repeat procedure

To set a PWM output:

10 Print#1 “TAxxxx”; Where xxxx goes from 0000 to 1024, 0000=0% and 1024=100%)

### 3.2.4. Field I/O Software Connections:

### On the Field I/O:

Pin DO,1 is a digital output pin.
Pin DI,10001 is a digital input pin.
Pin AO,30001 is an Analog output pin.
Pin AI,20001 is an Analog input pin.
TCP/IP Communication on the Ethernet port.

Sample list of connection types.

The communication between a computer and Field I/O is set by address tables. Values are written to addresses. The values written to the addresses are then transferred to the Field I/O using Standard Modbus Protocol.

With Field MT s, the pin configuration is already settled, we do not need to declare the pin modes. The addresses that are being written to already determine the pin mode of the address.

Each value for each address is written to the address within the Field I/O communication program. The program then updates the Field I/O with the values written to each address. The PC communicates with the Field I/O using ModBus Protocol over the Ethernet line. See Table 4.

The data written to the table is then continuously updated on the Field I/O.

### 3.3 How Mapping is Done

The PC has three pieces of software on it, a Graphical User Interface (GUI), the UDI, and a utility program to simplify installation, the Wizard. The latter program is used for setting up the DART to run for the first time and for upgrades or modifications. The UDI with its accompanying GUI are used during normal operation.

In the absence of an existing automation system in the factory, devices of the type already mentioned, need to be installed. If there is already an automation system in the factory, the user must create an I/O map that specifies the location on the engine that drives the particular device. Usually a PLC provides only one connection to the PC. If the PLC provides multiple connections to the PC, the user needs to specify the one he is using. To control two identical devices together, a connection can be made to one channel, such as, if for example, Steam In and Steam Output would normally be operated in tandem to prevent buildup of pressure. Thus, both may be connected to DOO for joint operation.

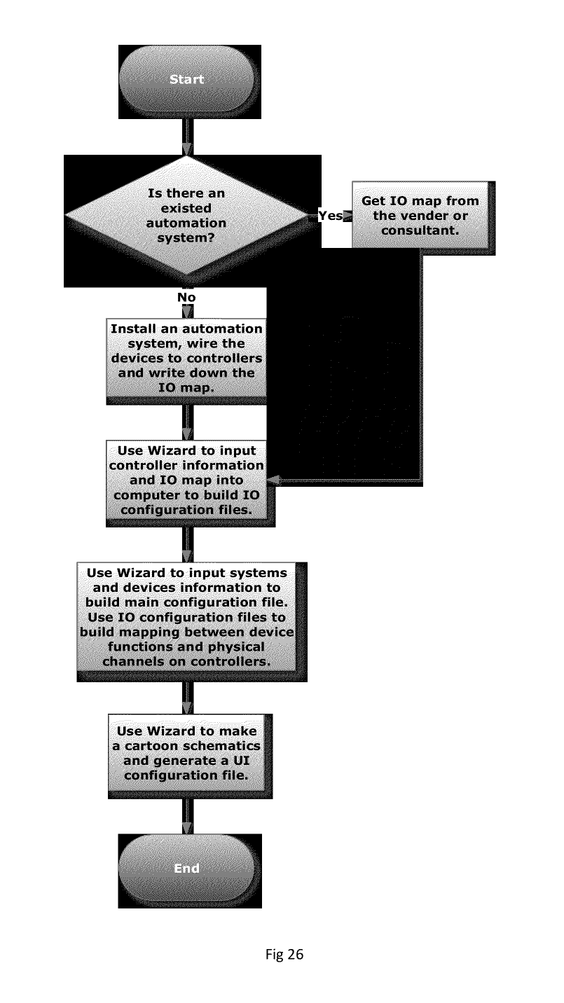

Either way, after the user has the I/O map, he can use the Wizard, FIG. 26 to configure the UDI and control system. The first step he needs to do is input his I/O map into the Wizard. He also needs to input the method that controllers use to connect to the computer and the parameters of the connection, such as the com port. After he inputs all the information of the I/O map, the Wizard generates one or multiple I/O configuration files, depending on how many controllers are in the control system. Users sometimes require multiple controllers to implement different functions, such as controlling motors only and another for general devices, such as valves, thermocouples.

The second step is to use the I/O configuration files to generate system structures and device information. Next the user inputs the information of every function of one specific device and specifies the port on IO configuration file to that function.

The last step is in this setup would be, in one embodiment of the invention, to make a cartoon schematic as in FIG. 1 and generate the UI configuration file. In this step the user chooses use some functions of some devices to build the dashboard and drags the devices to the schematic to make a cartoon GUI. This is shown by example in FIG. 26. These procedures are explained by example below.

The Wizard creates a configuration file that is used by the UDI and the GUI. The functions of the Wizard are:
Guide the user to setup the software according to the specific hardware connections of the connected controller.
Set the protocol and connection type to be used to communicate with the controller. These are given in 3.2.1 for the Arduino, 3.2.2 for the PLC, 3.2.3 for the Ontrak and 3.2.4 for the Field I/O.
Set the names which the user will use when guiding them through a mode of the Wizard called the Graphical User Interface Builder (GUIB).
Using the GUIB mode to create a cartoon image of the physical hardware setup for which the DART is connected. The GUIB maps buttons and symbols in the cartoon image to the physical controls that are connected to the controller.
In the specific case of the Arduino (3.2.1) to generate the configuration file which is sent to the controller to set the pin modes, and to set the format of the commands to be sent to the controller.

The Wizard prompts the user for information:
For the Arduino access is via 9600 Bps serial communication on COM 1, the virtual serial com port of the USB port.
For the PLC access is via 9600 Bps serial communication on the serial port.
For the Ontrak access is via 9600 Bps serial communication on the serial port.
For Field I/O access is Modbus via TCP/IP communication through the Ethernet connection.
The Pin mode of each pin on the engines: digital input, digital output, analog input, analog output. Tables 5, 6, 7, 8 for Arduino, PLC, Ontrak and Field I/O, respectively.
A unique name for each component connected to each pin. Tables 5, 6, 7, 8 for Arduino, PLC, Ontrak, and Field I/O, respectively.
The current hardware controller

The Wizard takes the information entered and generates a configuration file that is used by the UDI. The Wizard does this by comparing the data entered with a library of hardware configurations. Using the information in the library it formats the configuration file for the specific hardware it is connected to.

The libraries of the Wizard contain all of the hardware controllers with which it is compatible. Each library contains the information on how to communicate with each class of controller. The communication is in two parts. One is the physical connection between the PC and the controller, the second is the format of the commands to send to the controller. Physical connections are wired or wireless connections between the PC and the controller. Command formats are the specific characters, bits and protocols which must be used when communicating with the controller to perform some function.

The GUIB connects the UDI to the GUI using some information gathered by the Wizard. The GUIB asks the user to connect the unique name with a hardware control on the GUI. Then it asks them to input where it is physically located on the piece of equipment on which it is being used (Table 9).

Once the configuration file is fully established by the Wizard, the user can begin to automate the process using the GUI, which controls the UDI. The UDI is the translator between the commands placed in the GUI to the commands which are sent to the controller.

### 4.0 Implementation: The UDI Program Method Extended Beyond Chemical Processing

### 4.1 Laboratory Automation

The UDI Program can be applied in several areas besides batch processing. Another example is laboratory automation. In a sense, this extension may be thought of as a matter of scale, as for example with automatically filling or rinsing a container that would be used in collecting a sample to be measured in a laboratory. Essentially these activities are simply a miniaturization of the procedures outlined above, requiring pumps and valves, and used in ways previously described. Characteristically, this application may be done preferentially with smaller, less expensive controllers. For example, a field programmable gate array (FPGA) or even an Arduino processor would be sufficient for these benchtop-scale procedures.

There are additional items and concerns that distinguish the method in lab applications. Consider the case of a tray of liquid samples in test tubes. The samples may be arrayed in a matrix of M×N where there are M rows and N columns. The spacing between the tubes along a row is D_{R} and along a column is D_{C}. A simple measurement of pH is considered. A stationary electrode can be placed over the tray, and the tray moved in the beneath the probe; when a tube is positioned, the probe is lowered. Alternatively, and preferred strictly for the purposes of discussion, the tray could be stationary and the probe manipulated in a gantry-like fashion. This gantry arm would position the electrode above the test tubes and then lower it to take the measurements.

The use of stepper motors to selectively position items is a distinguishing feature in lab automation; so too is the step-and-repeat algorithm required. In effect, a three axis CNC machine is needed in this example of the extension of UDI Programs to the laboratory. This machine allows for movement of a universal test head in the X,Y (plane of the tray) and Z directions (raising/lowering of probe). Samples may be loaded in any configuration into the sample tray. The software then allows for the variations of sample configuration and allows procedures to be built around this arbitrary configuration. The software also allows for user defined testing procedures, which can be looped or single use.

When initializing the lab version as a three axis CNC machine, the user is presented with a menu with several options to choose from: Form Factor, Recipe Creation and Macro Editor.

The form factor (FF) menu is used for configuring the software of the machine to the current state of the hardware. It asks for several pieces of information, including the aforementioned number of elements and spacing in the tray. But it also provides for special situations such as a calibration station or wash station to which the probe may retreat for calibration or cleansing between measurements and also the very nature of the probe, which may be pH or conductivity or some other needed analytic tool. The sensors that can be attached can either be micro controller based or PC based.

Recipe creation is readily described by example. Consider a pH measurement probe attached to the test head of the gantry. The recipe creation tool dynamically produces the interface according to the form factor. When the recipe creation tool is clicked the software generates an image of a grid with the same number of rows and columns indicated in the FF. It uses the spacing for the X and Y information to calculate the center of each cell. The centers of each cell are assigned the location of each sample; this location is the location the probe will be instructed to go to while testing. The X and Y offsets can be used to translate the center locations for each sample in the x and y directions so that the center of each sample is sampled. The minimum Z clearance is used to indicate how much travel the z axis must use when it is plunging the test head into the sample medium.

It is important to the success of this effort that instructions be created to enable each motor to move a specified number of steps. Thus, when the X-axis motor is prompted, a popup requests information about the number of steps, etc. This protocol is the elementary operation scheme for each motor. However, it is even more convenient to use the Macro feature of the UDI Program to combine actions of all the motors and, with knowledge of the form factor, enable simplified programming

In the recipe editor the user is presented with a graphic of the layout of the sample chambers of the machine. The user is prompted to select the cells that are to have macros run on them. Selecting the cells can be done in several ways. Users can select to add cells by the order in which they were selected, or by a sorting algorithm which will optimize the tool path to minimize the amount of distance the test head must move through. Upon selection of the cells the indication to test the cells is added to the recipe editor. Other types of manipulation to the recipe are possible through this interface. A schedule of how often to perform actions at special cells is then inserted into the recipe. For example, after every N tests on a sample the test head should move to the wash cell. These types of special actions, as well as the testing procedure itself are configured in the macro editor.

The macro editor allows for control of the testing procedure, meaning that a wide variety of implementations are possible. In the macro editor the testing procedure is defined through a graphical interface with icons that perform functions that permit looping instructions. The user is asked to create a macro and define all of the steps for it. For example, a sample test procedure can be generated to dip the test probe into a solution, run a pH test, and then move to the next cell. A sample of how a micro-recipe to test and record pH may be defined, is:

Move test head to current sample location

Move test head z axis down by half the minimum z clearance.

Activate the test head and record the value received into memory

Move test head z axis up by half the minimum z clearance

Wash test head

The example of a gantry measurement is meant to illustrate the nature of the concept. Extension to other applications such as delivery of wafers into an oven or of creating repeated small scale mixing experiments to test product formulations are included by implication.

### 4.2 Compound Analyzers

It is commonly understood that many manufacturing processes require quality control checks while the product is being manufactured. This is frequently true in the chemical manufacturing business, where a batch may be stopped so that a sample may be drawn and then taken to a quality control lab for analysis. At the lab, the technician frequently needs to prepare the sample for analysis, using multiple standard procedures such as dilution, addition of reagents, and heating.

The UDI Program-based technology, particularly the lab automation variant is proposed as an alternative, and on-site, means of doing this analysis. One embodiment is an electrochemical measurement wherein a sample is drawn from a vessel using a tube immersed in the tank and a metering pump to draw a measured amount of chemical into a receptacle. To this sample, another metering pump adds a second fluid, either for dilution or to produce a desired chemical reaction. Next, the measurement is made. Finally, the receptacle is emptied, either by opening a valve or by drawing off the sample with a pump; a wash solution may also be used. Then this automated analyzer is ready for the next sample.

Preferentially, the entire automated analyzer may be assembled at a user's laboratory and programmed with a PC as discussed with the laboratory automation application. Upon completing the assembly and testing, the user may then disengage the PC and deliver just the controller, here considered to be a simple FPGA or even an Arduino, downloading the recipe scheme to the controller. For this application, the flexibility of reprogramming is not needed, since the lab automation device is called upon to emulate the procedure that would ordinarily be done by the technician at the quality control laboratory.

The microprocessor-based unit, now without the UDI Program-containing PC, is referred to as a compound analyzer. This transferred microprocessor-based unit is connected to the PC controlling the manufacturing process, but it serves strictly as an analyzer. The device may be connected via USB or Ethernet or serial port.

The measuring unit, as for example the electrochemical analyzer, can upload its result to the microcontroller so that, preferably only one connection between the compound analyzer and the controller operating the batch is needed. It is understood, however, the on occasion, a more complex measurement, such as that encountered in optical spectroscopy, may be required. At this time a processor, perhaps a PC is needed for the operation of the optical device. If the complex data measured in this separate PC can be processed in that same PC and a result derived, this result may then be uploaded to the microcontroller, preserving the one-connection method. An example of such simplification is the requirement to color-match a sample. The compound analyzer may have diluted the batch sample with a white base prior to the optical measurement. The PC associated with the optical unit may have in its database the specification to match and return a yes/no result to the controller.

This compound analyzer is based on the UDI Program method, modified by the laboratory automation scheme, and further simplified by the removal of the PC and use as a special function, on-site device. Further enhancing it by allowing either a switch of processors or the downloading and incorporation of multiple programs is included within the scope of the embodiments described herein.

### 5.0 The Supervisor/Scheduler

While industrial process can be controlled using the apparatus and methods as described above, as previously stated, it is often difficult for a chemical or other production facility to properly schedule and supervise a particular production run, or even more significantly, numerous production runs for a variety of customers. Raw materials, equipment and personnel must all be available at the right time. Further, the production process must be monitored, and information must often be supplied to customers to assure them that the products they need will be available on time. A system for performing these functions is described below.

One of the purposes of the Supervisor/Scheduler is to reduce the complexity of planning where to manufacture batches. For example, some products will require vessels of a certain minimum (or maximum) size; others will need special features such as vacuum ability; and yet others will benefit from specific types of on-line analyzers. The use of a walk-through method reduces the complexity of decision making, enabling modestly trained or even untrained individuals to act in a supervisory role. Once a user has selected a type of product to be made, particularly if a similar one has already been made and is included in the database, the user is constrained by the Supervisor/Scheduler to make selections on the basis of a limited allowable set. Hence, when scheduling a product known to require vacuum processing, the user will not be offered the opportunity to consider vessels not so equipped. Similarly, when the UDI Recipe requires the product to be made with a color optical analyzer, installations properly equipped will be offered.

A fully implemented data base, then, will enable virtually anyone to schedule a batch since the choices will be simplified, reduced to where the product can actually be produced. And when features are not available, for example a color optical analyzer is needed and no vessels otherwise suitable are available with such analyzer, the user is able to order the installation of the required analyzer and modify the database to show its availability.

As will be explained below, the Supervisor/Scheduler consists of two programs. One, the LocalSS is based at the computer that controls the batch. This module provides information to the worker on-site, such information, in general having been created off-site as by a supervisor specifying the details of a production run. The supervisor, in turn, uses the WebSS, a cloud-based module to create the information in question. Additionally, the Supervisor/Scheduler in the local computer gathers relevant site information ranging from run-time parameters obtained from the controller or from analyzers and uploads these data to the cloud. Remote users then may access the cloud and obtain the desired information.

### 5.1 Using the Supervisor/Scheduler

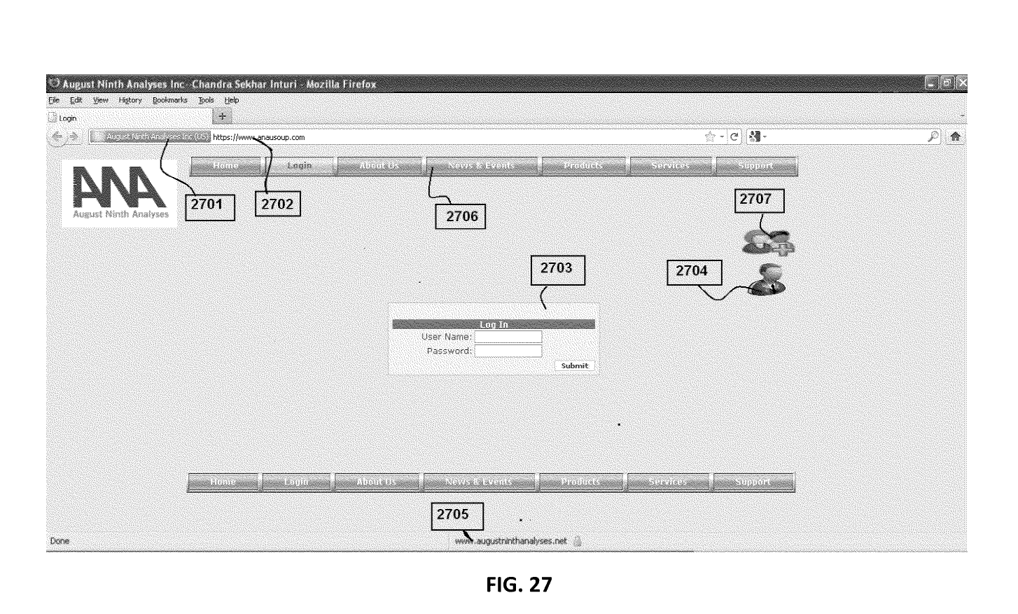

As shown in FIG. 27, the implementation is browser based. A user keys-in at the specified url and then sees a login screen. The user is requested to key in the desired user ID and password. In a preferred embodiment the system is secure and a green address bar 2701 and lock symbol 2705 are seen.

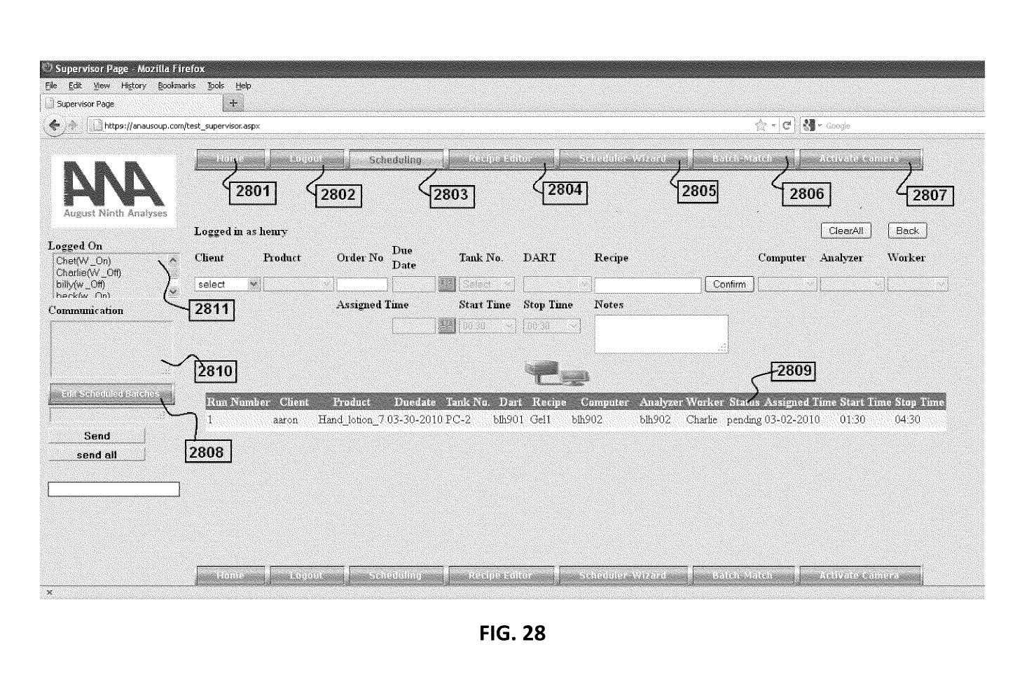

Once the user has logged in, a server will direct the user to the respective user pages of Supervisor, Worker, and Client. FIG. 28 shows the Supervisor Page. A typical system GUI of this software contains five sections; (1) upper left section 2811 indicates the users online and offline; (2) left section 2810 is an Instant Messenger box; (3) top middle section is walk through process of scheduling manufacturing procedure; (4) lower middle section 2809 is pre-scheduled manufacturing procedure available for monitoring; and (5) top right section (2801 . . . 2807) of the browser are the tools such as logout, historical database query, and edit tools.

The user schedules manufacturing process with the help of walk through GUI. Walk through GUI is comprised mainly of user drop-downs and the last drop down of the GUI is noted as Nth dropdown with it value as zero (N==0) by WebSS program. This walk through allows the user to make a single choice at a time, such choice potentially affecting the range of possibility of the next choice to be made. A relational database is the backbone of this walk through process. A remote database on an independent server communicates with the local database on a 24/7 basis and categorizes all the available components. While this server may be on an Intranet arrangement to enable containment of all the data to the user's own location, the example shown here and throughout the discussion is based on the World Wide Web. Either method may be used without loss of generality of the invention.

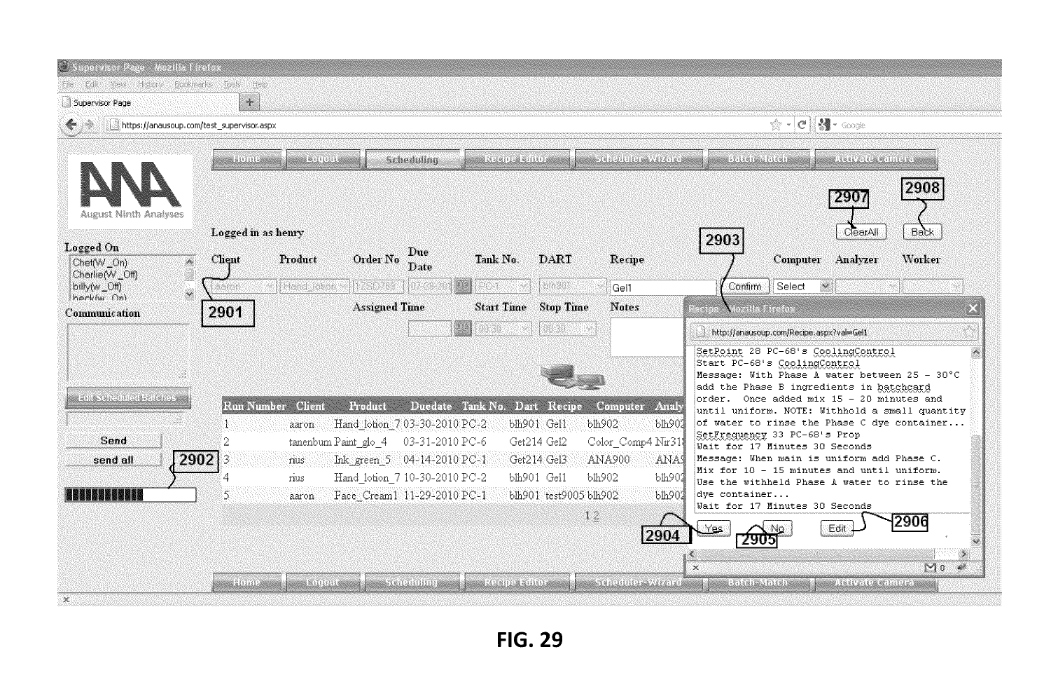

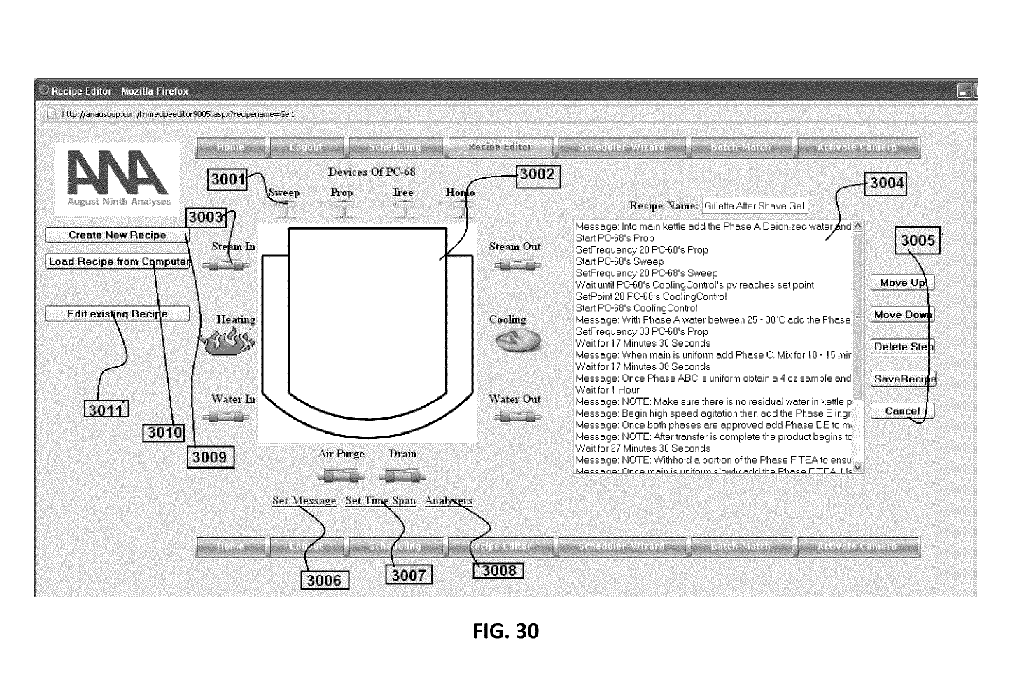

As shown in FIG. 29, the first step in the process to be specified is enabled at 2901. The second step is enabled depending upon the first step's chosen value. Future enabling is a derivative of past chosen value. At the Recipe step, the user will be shown the entire instruction set at 2903 for confirmation. The user can confirm by pressing “Yes” at 2904 or deny by pressing “No” at 2905 and “Edit” at 2906 to modify the manufacturing procedure.

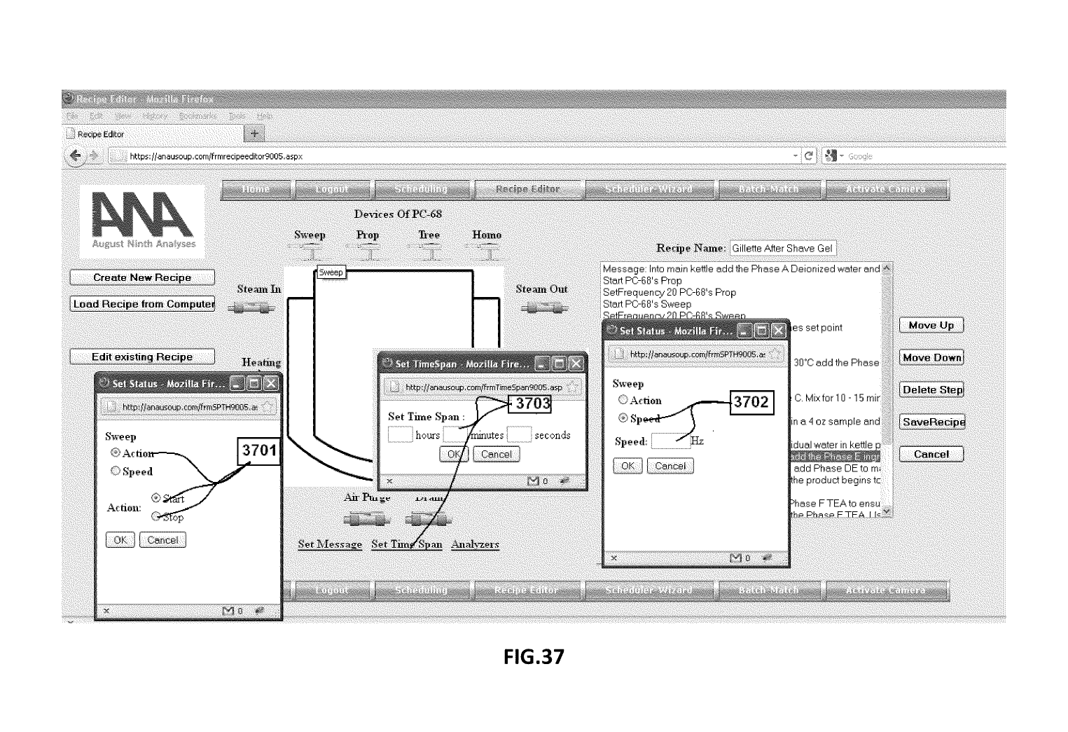

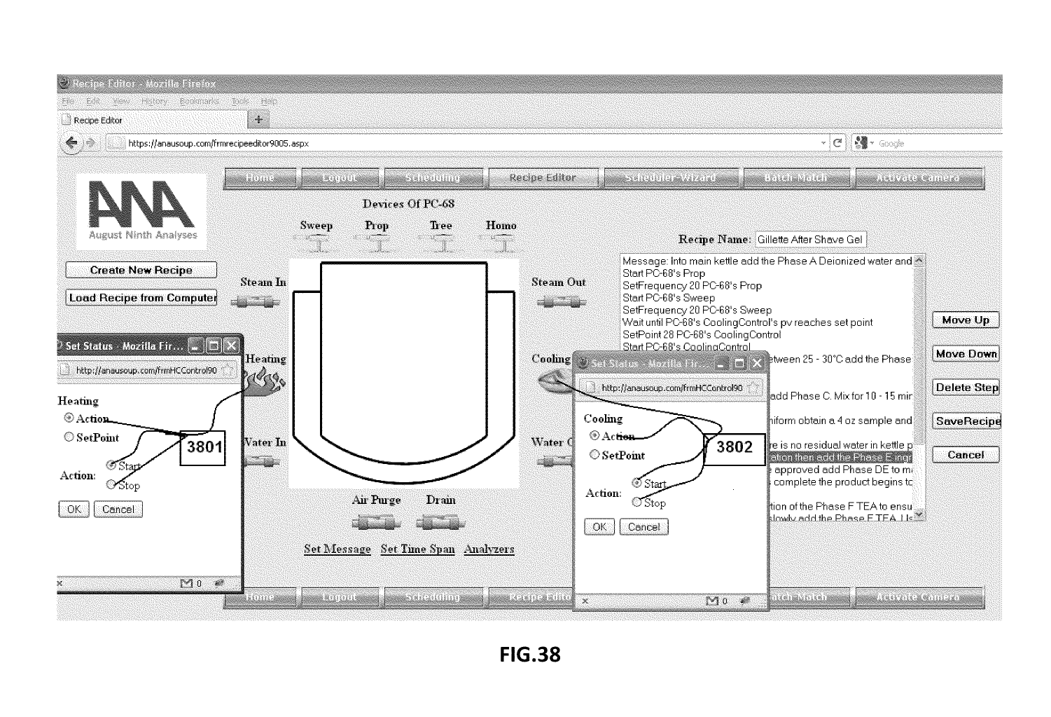

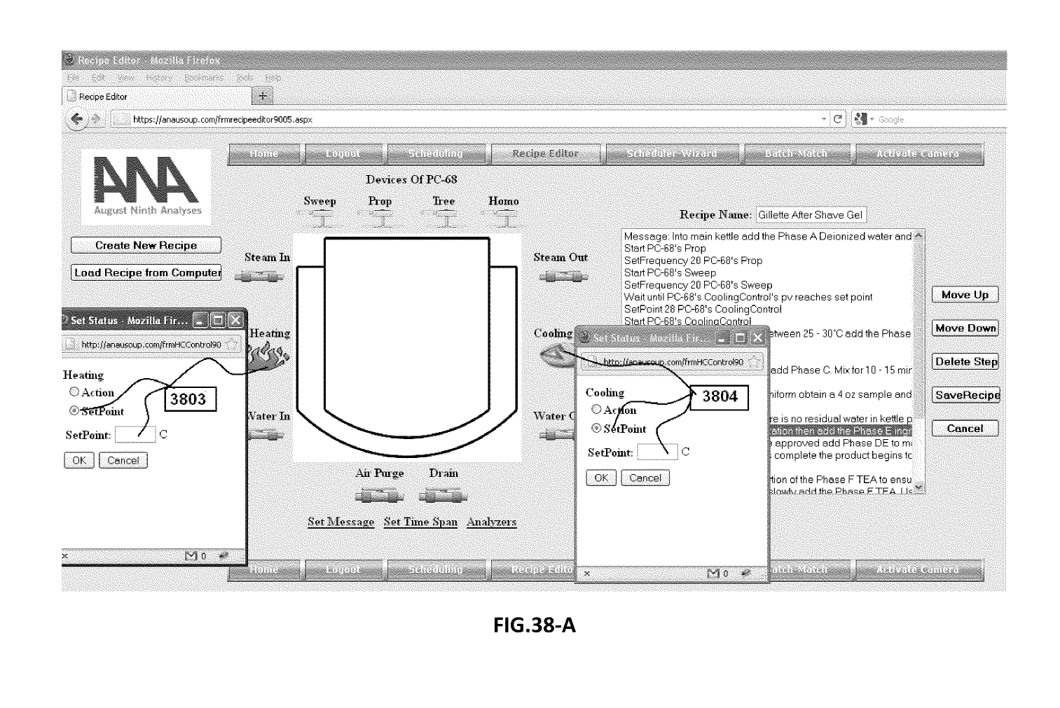

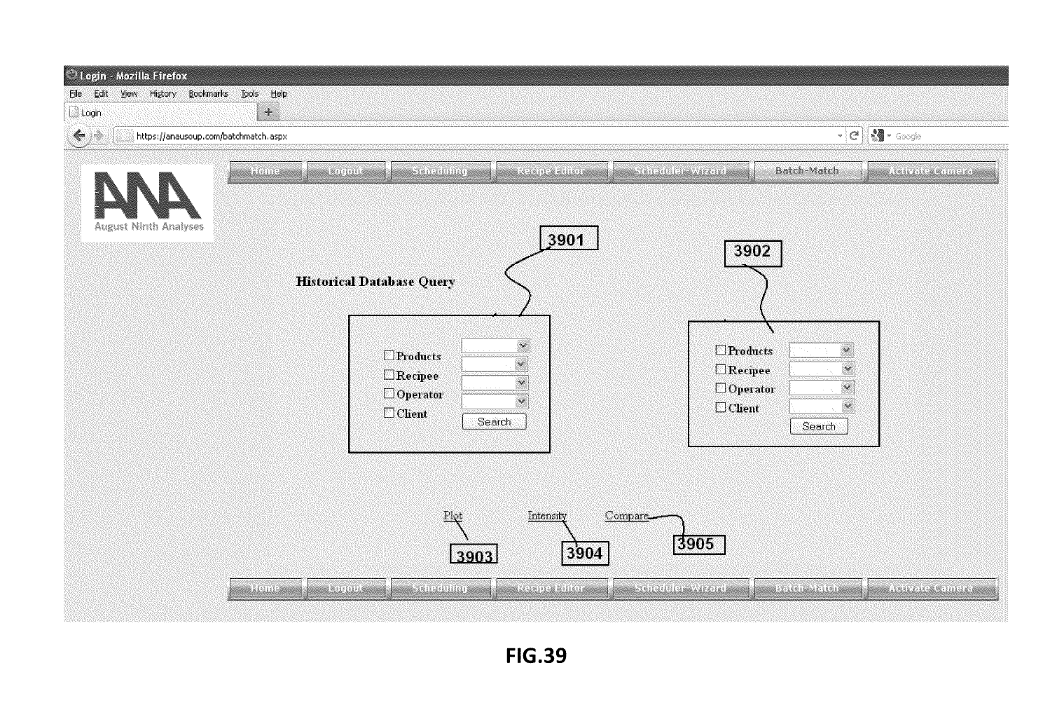

Editing of the manufacturing procedure may be accomplished easily with a single click. The user can just click on the icon of sweep 3001, or any of the other functional items such as tree, valves, steam 3003 etc. The step will automatically appear in the recipe editor box 3004. This is another—but separate—embodiment of the Recipe Editor. The prior version was generated at the UDI; this current method is done on at a PC connected to the Internet and not at all directly connected with the active batch manufacturing area. The procedures done are not interactive with the manufacturing site and can be done independent of whether the site is running a batch, idle or even in a nonfunctioning state. This part of the Supervisor/Scheduler is for preparing to run a batch in the future. Addition of conditions, as for example, enabling temperature, is achieved by guiding the user and providing certain pre-determined conditions/user key-in and can be observed in FIGS. 37, 38 and 38A. The run time conditions for several anticipated batches are shown in 3103.

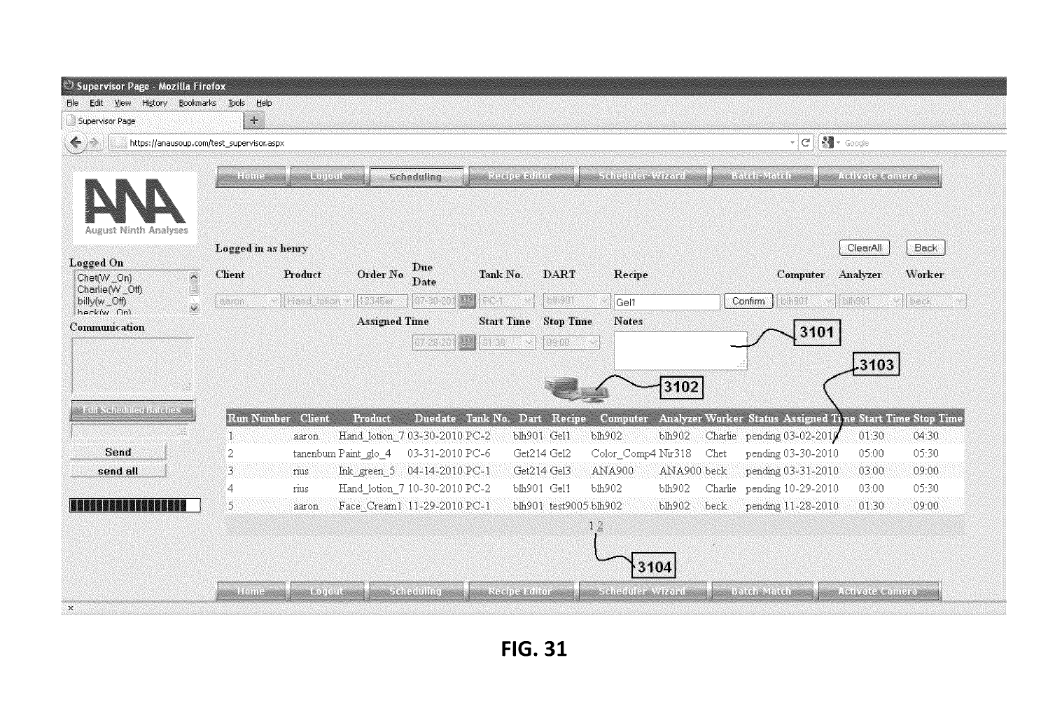

Authorization and validation of the manufacturing process is done through the control shown in 3102 of FIG. 31. By clicking that control, the user authenticates the manufacturing procedure, meaning that the parameters entered are accepted for the scheduled run. Following that acceptance procedure these parameters are downloaded from the user's server to the computer at the specified manufacture vessel, where it is stored in a local database. Additionally, the pre-scheduled manufacturing procedure table is updated on the server by updating the remote database there. This second update provides web-based schedules that are current for authorized users to check.

5.2 Real time System Monitoring

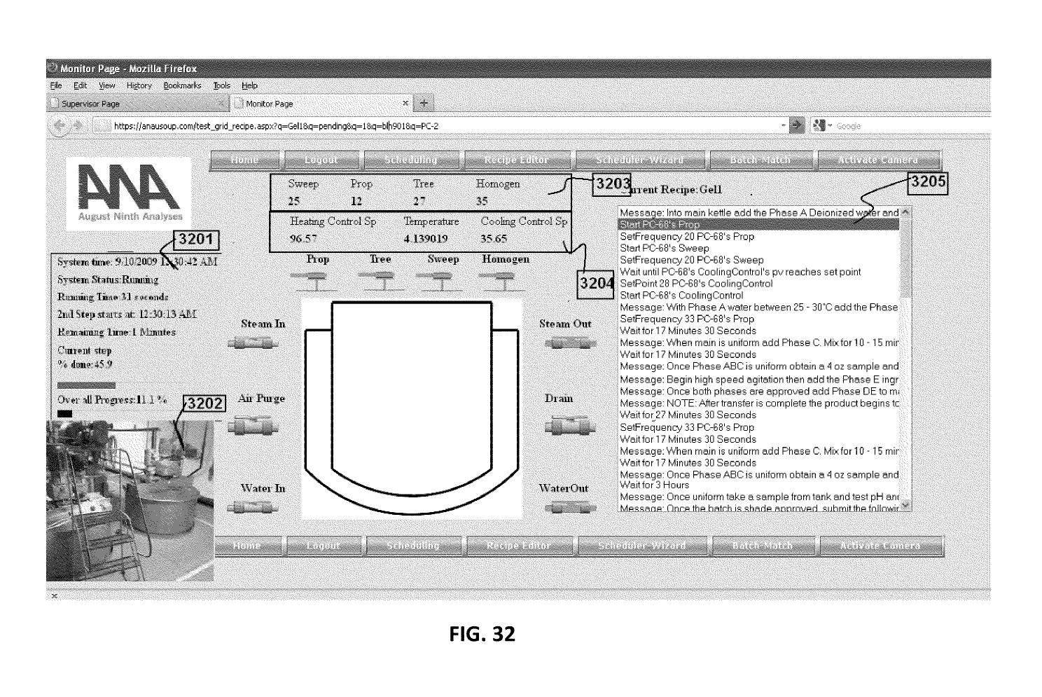

Monitoring of manufacturing procedure is done by clicking on any pending tasks of the pre-scheduled manufacturing table 3103. By doing so, the user will see the display of FIG. 32. This GUI control monitoring process is real time, with global access and contains system status box 3201 on the top left side, local station camera view 3202 below the system status box, and a GUI of the tank in which the process is being carried out. In the GUI icons are colored, red indicating that the corresponding functionality is “off” and green indicating that is “on”. Status indicators 3203 show frequencies of motors; thermal control parameters 3204 show heating-, cooling- and temperature-related variables. All of these parameters are real-time values transferred from the manufacturing site, as will be explained later, for use web-based observers off-site.

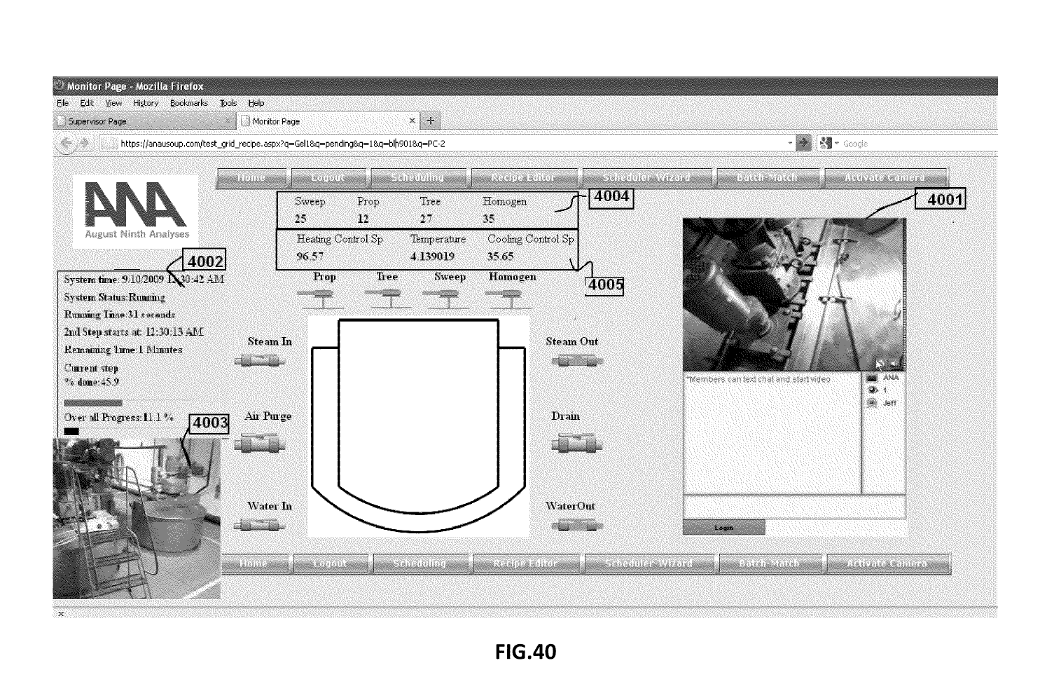

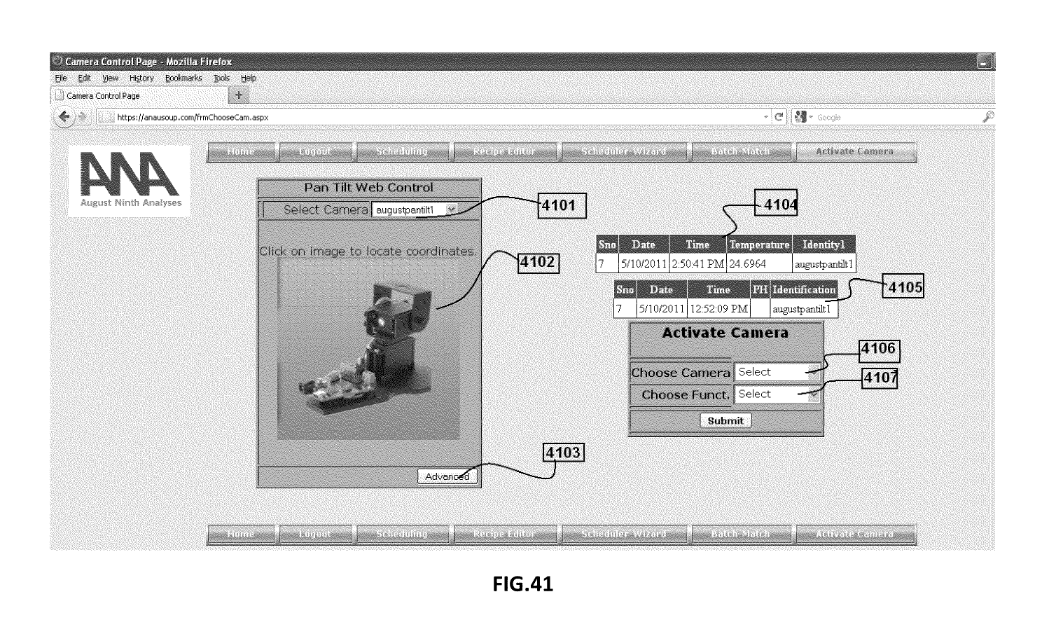

Thus far, the user could be expected to have been a plant supervisor. This user planned the batch and observed it operating. But the login shown in FIG. 27 could also be done by another category of user, a presumed client for whom real-time observation of the client's batch may be desirable. FIG. 40 shows a screen suitable for clients. In this and indeed, all web-based embodiments, there is no option for control. Icons may glow red or green to indicate device status, but the user is merely an observer. The incapacity of a web-based observer to connect to the vessel to and activate functions at the vessel is an intended restriction, a safety feature of this embodiment. Additionally, plant management, although willing to show the client a great deal about the client's batch, may also chose to offer a more limited amount of data than would be offered to plant personnel. In FIG. 40 additional video 4001 is shown in place of the Recipe 3205. The Supervisor/Scheduler also has the ability to remotely activate 4106, 4107 and stream live video to web interface from any cameras inside batch manufacturing plant which can be observed in FIG. 41.

5.3 Running the Batch with the Supervisor/Scheduler

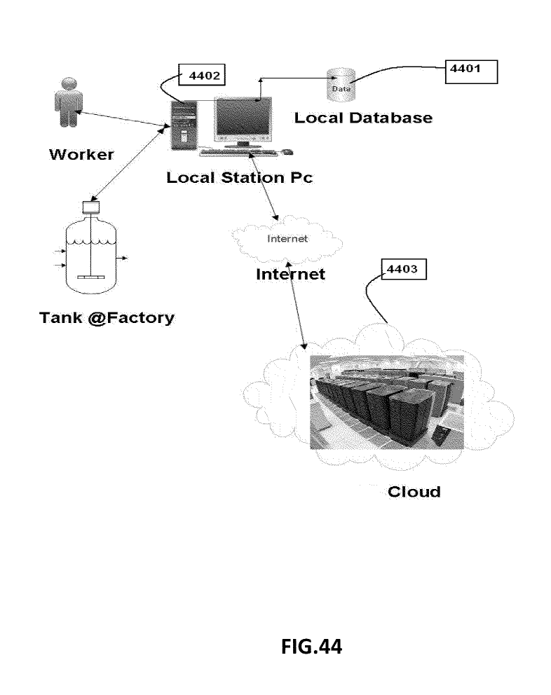

The third category of the user-triad after Supervisor and Client, is the Worker. The worker in the plant has local control from the local personal computer in the plant, as represented by FIG. 44. On the day of the job, the worker simply logs into a local station 4402 (PC that is responsible for manufacturing that particular batch). After login, the UDI and the scheduler do two principal things:

1) The local database 4401 is compared to a remote database (in the cloud 4403) and a verification is performed to check if there were any changes made overnight by a supervisor. If changes were made, the worker will see an updated manufacturing task. This update may include physical modifications required of the worker such as the selection of alternative ingredients for the batch or even the need to connect an analyzer.
2) Once these tasks are done and confirmed by the worker, the system is ready for manufacture. Generally, this means that the local personal computer is enabled to start the automated process according to the prescription of the Recipe.

### 5.4 Editing the Supervisor/Scheduler

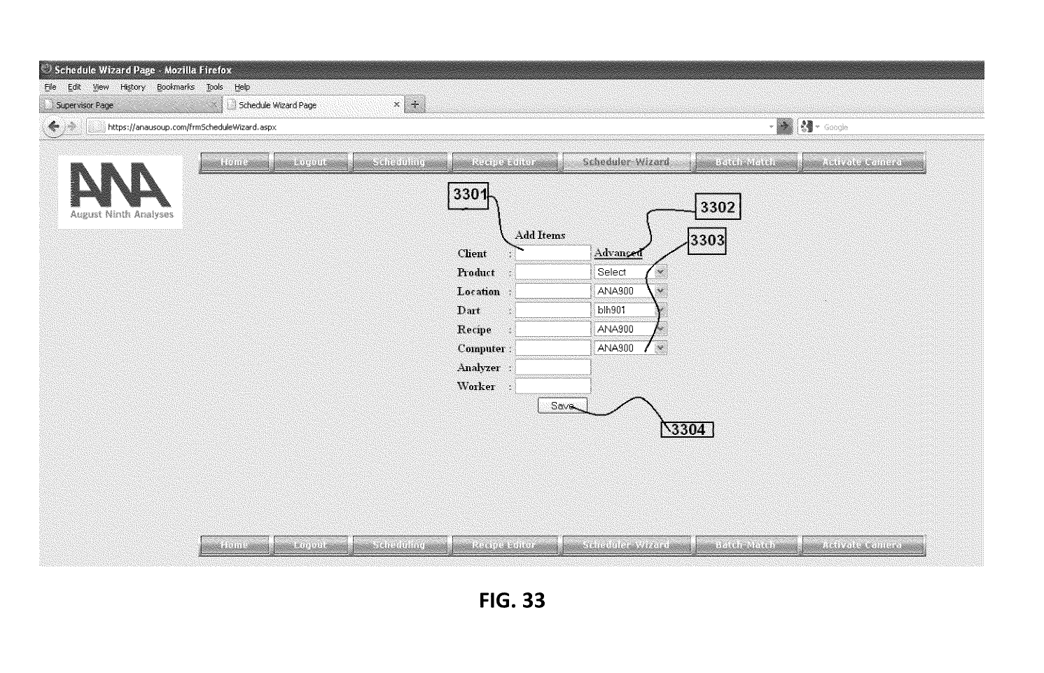

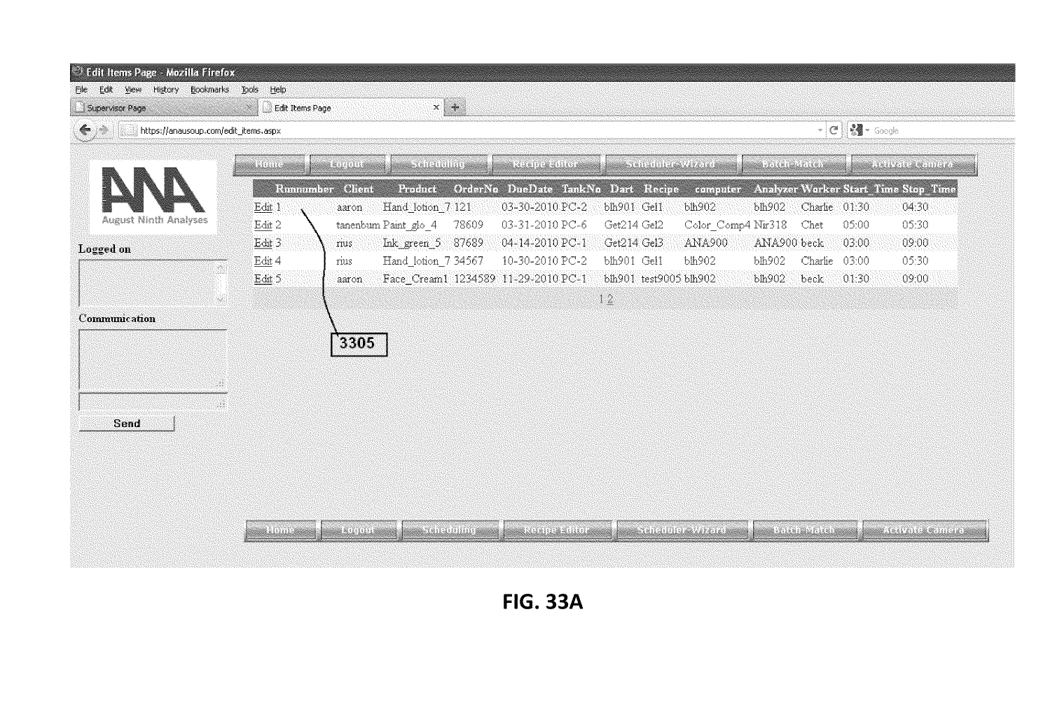

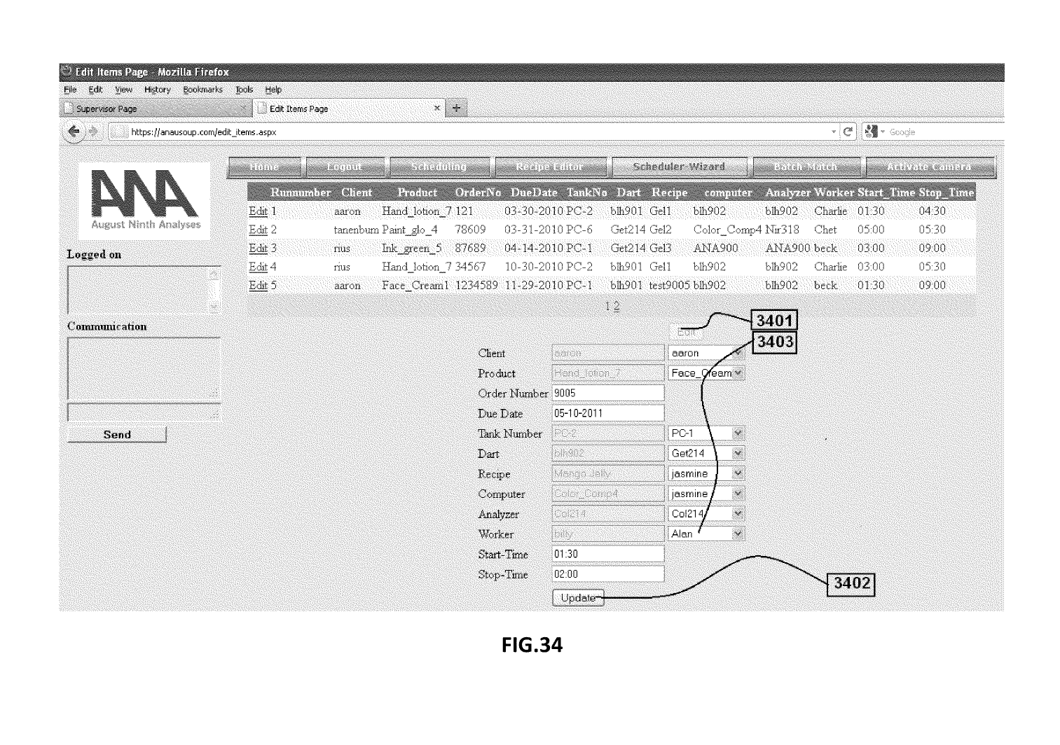

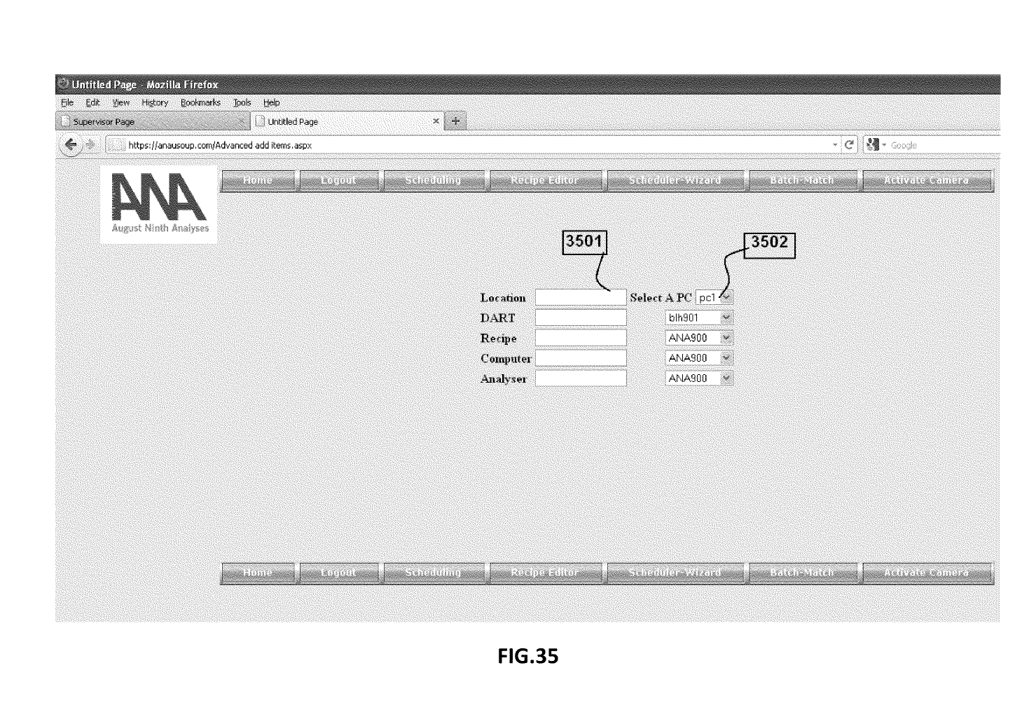

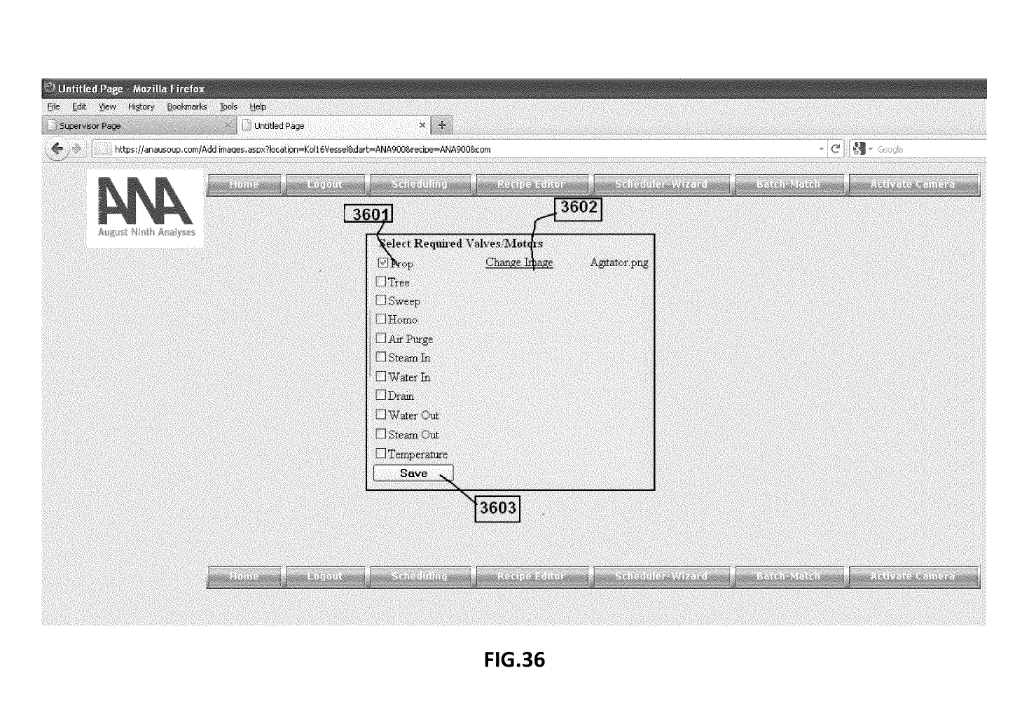

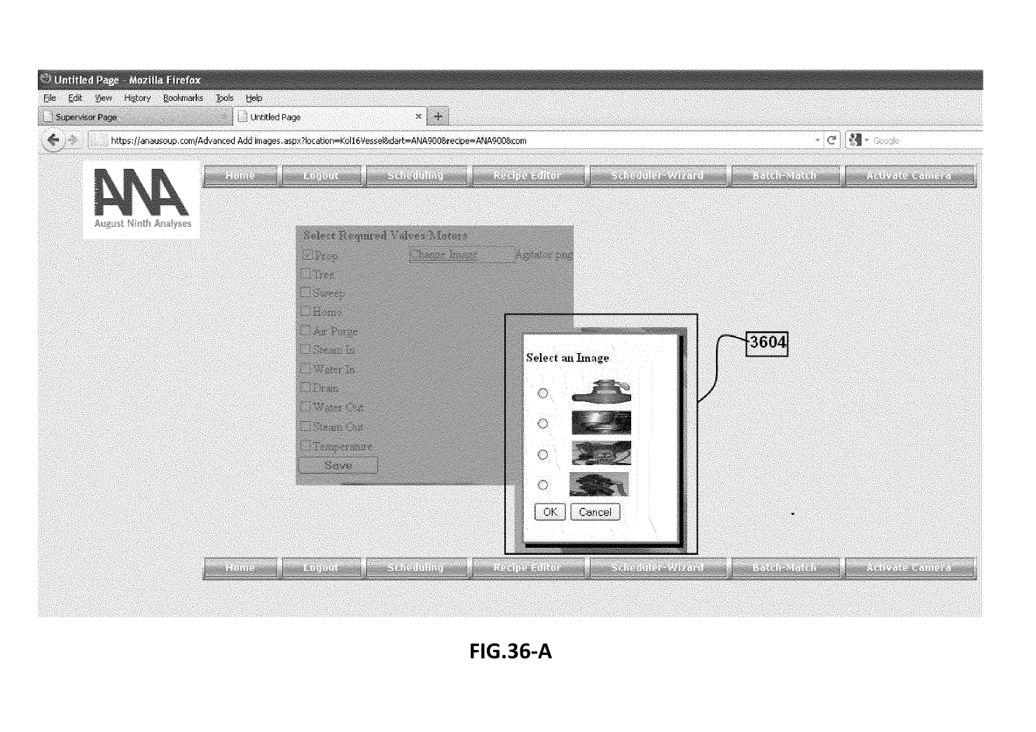

Addition of new details to the categories and editing of the current pending manufacturing process is done through the editing features shown in FIGS. 33, 33A and 34. The scheduler is user customizable as is represented in FIGS. 35, 36 and 36A. An authorized user, i.e. someone with a login status high enough to make system modifications is able to upload the original pictures of tank, motors, valves etc. and change the default GUI 3601, 3602 and 3603 into an original design look 3604. This higher-status distinction can lead to a fourth category beyond Supervisor, Client and Worker, perhaps a General Manager; alternatively it could be part of the Supervisor classification.

### 5.5 The Architecture of the Supervisor/Scheduler

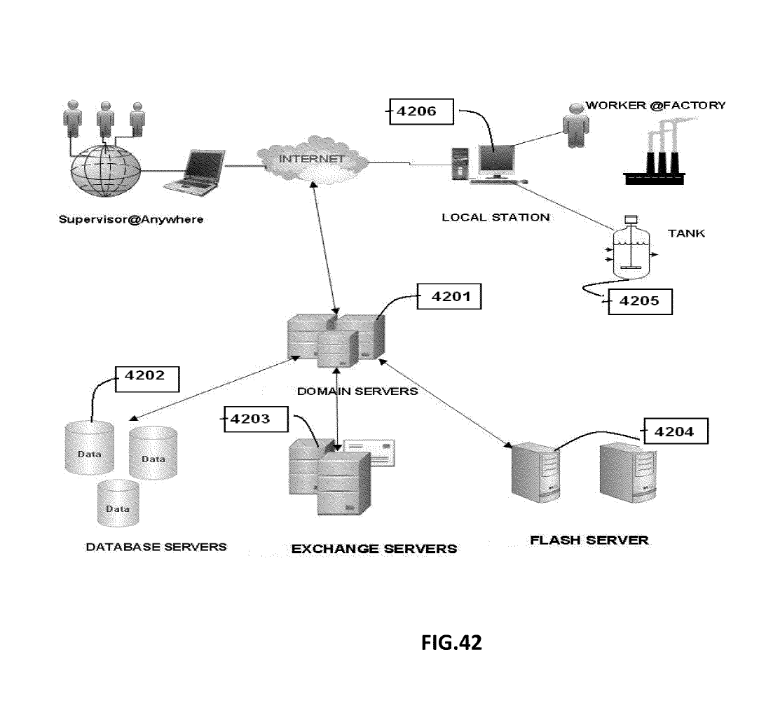

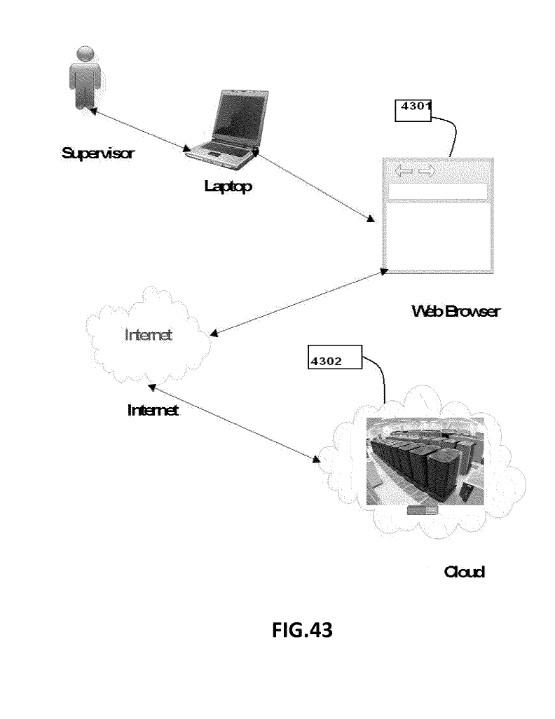

A general schematic of components of a Supervisor Scheduler network is shown in FIG. 42. Each component whether at the same or a different location can act independent of each other with integrity. The Supervisor Scheduler will have one remote network and n number of local stations. The supervisor accesses the Supervisor Scheduler via the internet. Thus, the boundaries of the Supervisor are limitless; i.e. control and access to local as well as to remote sites is available to the supervisor as shown in FIG. 43.

### 5.5.1 The Overall Scheme

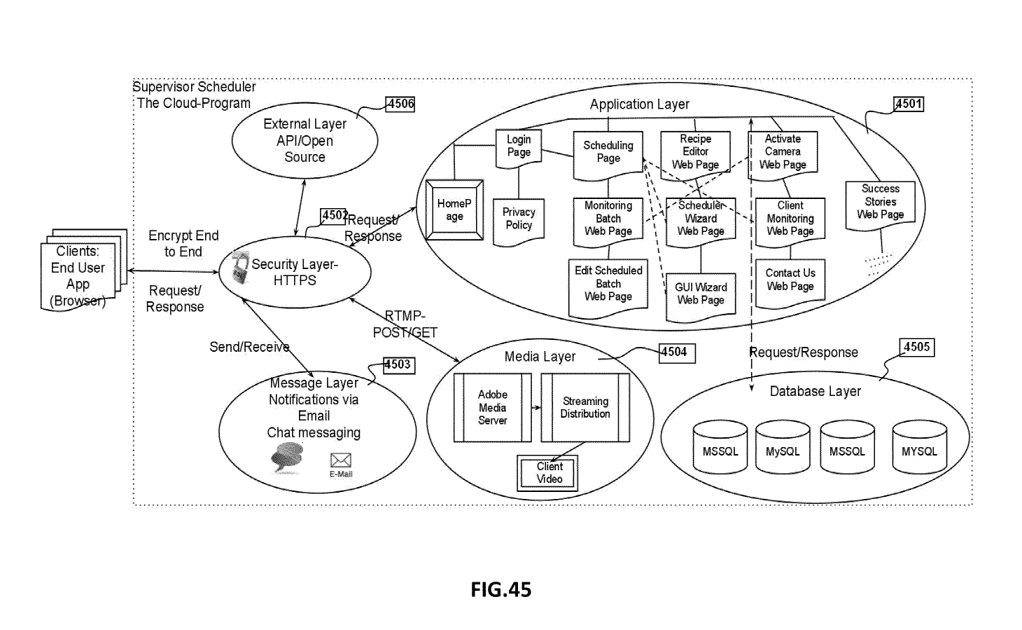

Flow of information is as shown in FIG. 45, which illustrates different layers that are involved in the cloud. The layers are simply representative of the flow/architecture of the program. The Scheduler includes the following layers:

### 1. Application Layer 4501

This layer is a general purpose layer. All layers discussed below are called by this layer, processed by this layer, and interfaced by this layer to the end user. For example, if the user needs to analyze a current batch manufacturing process with respect to data in the historical database, the user request is processed in this layer, and the results sent back to the user.

### 2. Security Layer 4502

This layer ensures that all flow of information between the cloud and the local station is encrypted. This layer is controlled by an independent entity who are retained to continuously update security features so that there is no compromise in security.

### 3. Media Layer 4504

The function of this layer is to assure that all video communication works smoothly as programmed by the programmer (see section on video technology below). If changes or upgrades to video communication are implemented only this layer need be changed.

### 4. Message Layer 4503

The main function of this layer is to enable chat/messenger communication to operate, so that communication between the supervisor, the client and the worker are done smoothly. If any new features are developed, only this layer will need to be updated.

### 5. Storage Layer 4505

This layer stores all data for entire cloud, as well as data processing algorithms. The entire database is in this layer.

### 6. External Layer 4506

This layer is generally for use by customers to customize their product, i.e. this layer is used to add some external devices that are not generally part of the system described herein.

5.5.2 How Information is Transferred with the Supervisor/Scheduler

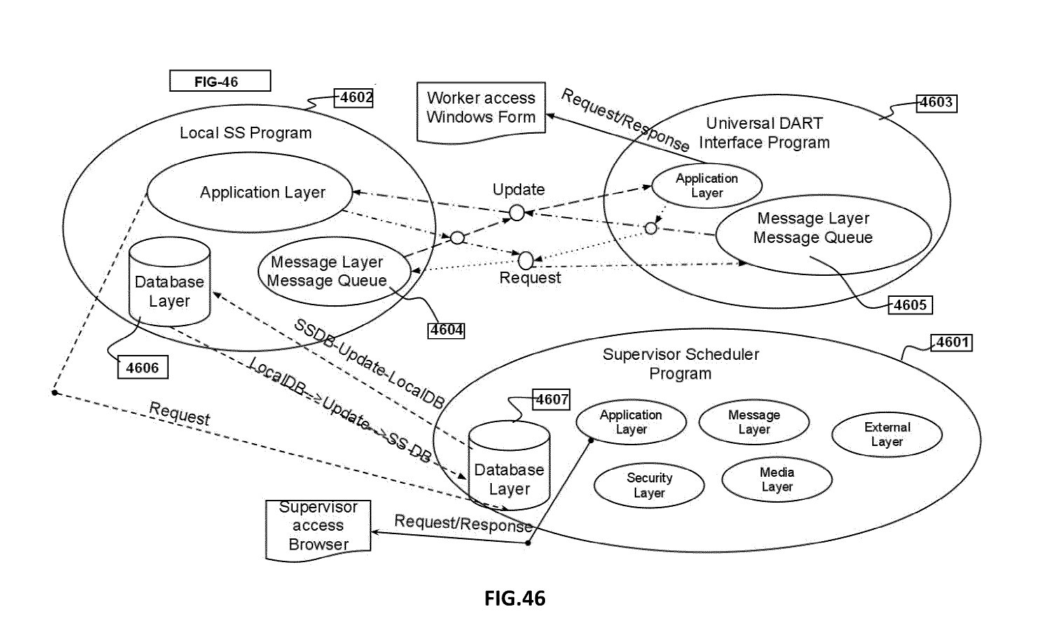

Flow of data from UDI to LocalSS and from LocalSS to WebSS is as shown in FIG. 46. The function of this interface layer is to update/transfer data between UDI, LocalSS and WebSS synchronously. In the current embodiment a loop executes every 60 seconds using request, update (response) protocol. For data transfer and data update between UDI and LocalSS Message-Queue is the tool used. For data transfer and data update between LocalSS and WebSS Database-Functions are the tools used.

### 1. Data Transfer and Update Between LocalSS and UDI

Required data such as Recipe instruction set, authentication details, location, tanks, PC, check list that is needed by UDI are inserted by LocalSS into UDI_Message_Queue 4605 auto asynchronously. The UDI synchronously or asynchronously sends requests (query) to UDI_Message_Queue for any new data present in the queue and UDI_Message_Queue sends response to UDI (response-new data). Upon receipt of the data by UDI, UDI empties the queue.

Similarly, required recipe step number being executed; motor and valve states (on or off); motor speeds; temperature; batch run time, recipe name, tank number and estimated time for completion that is needed by LocalSS are inserted by UDI into SS_Message_Queue 4605 auto asynchronously. Local SS synchronously sends requests (query) to SS_Message_Queue for any new data present in the queue and SS_Message_Queue sends response to LocalSS (response-new data). Upon receipt of the data by LocalSS, Local SS inserts new received data from SS_Message_Queue into Local SS database and then LocalSS empties the queue.

Note that in the current embodiment both UDI and LocalSS send requests to message queue and message queue send response (update) to both UDI and LocalSS. If the response from UDI_Message_Queue and SS_Message_Queue to UDI and LocalSS is no new data or empty queue, no action is taken either by UDI or LocalSS and loop continues to execute till the program is terminated.

### 2. Data Transfer/Data Update Between LocalSS and WebSS

Required data such as run number, client name, product name, order number, due data, location, UDI, recipe instruction set, analyzer name, worker name, assigned time, notes etc that is need by LocalSS are inserted by WebSS into dbo.worker_localSS data-table 4607 (this data table is physically located in cloud database server) auto asynchronously. LocalSS synchronously sends request (query) to dbo.worker_localSS data-table for any new data present in data table and dbo.worker_localSS data table sends response (yes/no) to localSS. If response is yes, all the new parameters from dbo.worker_localSS data-table are downloaded from server and stored in localSS database.

Similarly, required data such as RTD_Temp, Recipe Name, Recipe_Status, Recipe Current Step, Recipe_finished_percentage, sweep_status, prop_status, tree_status, homogen_status, steamin_status, steam_out status, heating_setpoint, cooling_setpoint etc that is needed by WebSS are inserted by LocalSS into dbo.Tanks_values_WebSS data-table 4706 (this data-table is physically located in Local Network of Client manufacturing site) auto asynchronously. WebSS synchronously sends request (query) to dbo.Tanks_values_WebSS for any new data present in data table and dbo.Tanks_values_WebSS data table sends response (yes/no) to WebSS. If response is yes, all the new parameters from dbo.Tanks_values_WebSS are uploaded from localSS database to server.

Note that in the current embodiment both WebSS and LocalSS send requests to data-table that exits in database and data-tables send response (update) to both WebSS and LocalSS. If the response from dbo.Tanks_values_WebSS and dbo.worker_localSS to WebSS and LocalSS is no new data, no action is taken either by WebSS or LocalSS and loop continues to execute till the program is terminated.

### 5.5.3 Internal Database Structure of WebSS 31-D

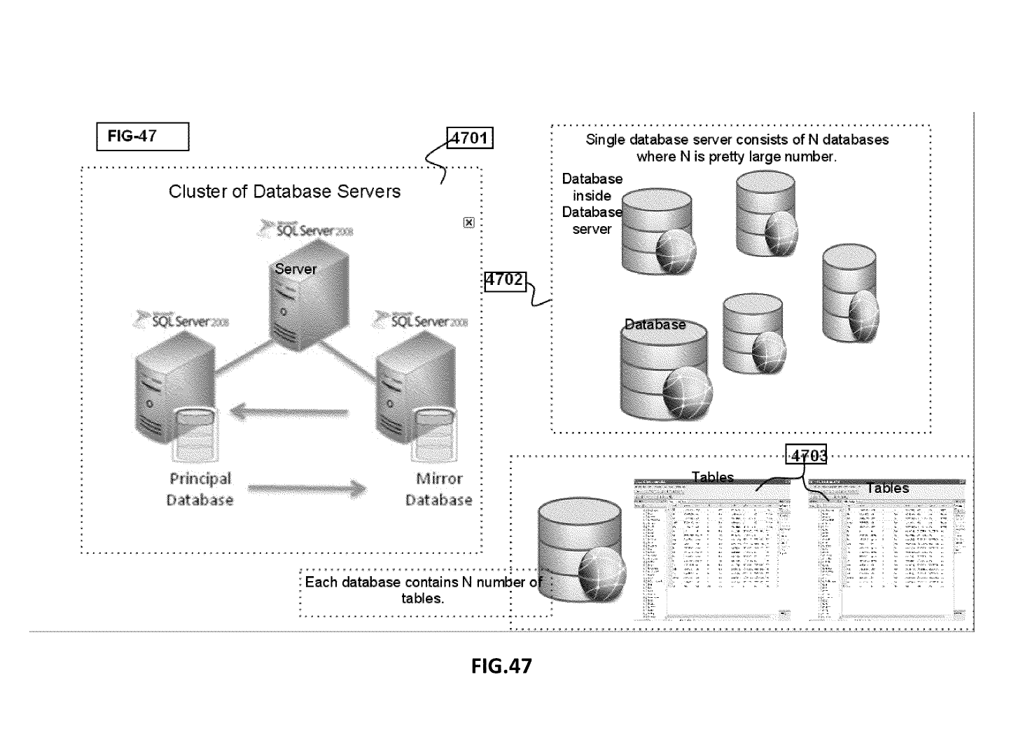

FIG. 47 represents the relational database structure of the database layer. The data base of the WebSS is comprised of a plurality of database servers 4701.

Each database server accommodates a plurality of databases 4702 depending upon size, strength (processing speed and disk space). The expected range is a minimum of 100 databases to many thousands. Each database accommodates a plurality of data tables 4703. Each data table consists of fields where Supervisor/Scheduler information i.e. data is stored. Any new data-tables to be created or existing data table structure to be changed in databases, only that particular part of data-table can be programmed by programmers without effecting entire application. Once new changes are made, both localSS and WebSS update automatically with new changes by auto downloading/uploading new data-tables.

Note that in the current structure any new changes in future doesn't affect day to day running operations of Web-SS or Local-SS and both WebSS and LocalSS auto-update each other thereby promising 99.99% uptime.

### 5.6 Procedures of the Supervisor/Scheduler

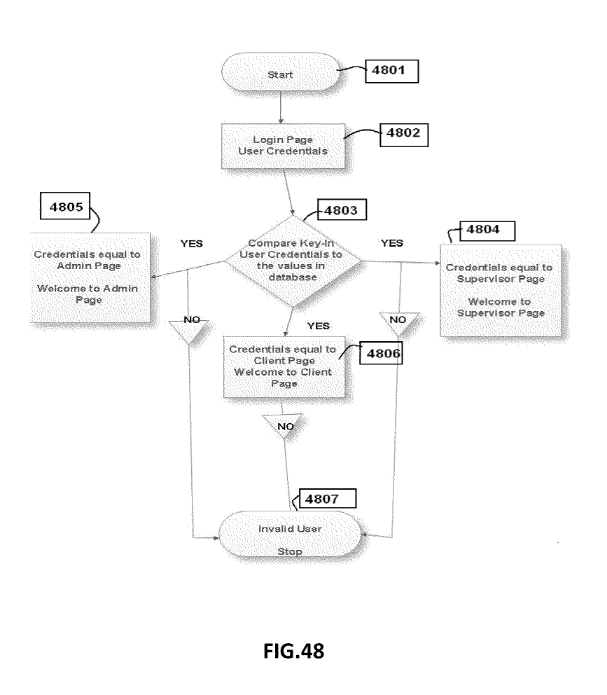

FIG. 48 illustrates the login procedure, starting at 4801. Initially at 4802, user is requested to key in the desired user ID and password. At 3203, WebSS verifies user credentials, identify whether it is client or supervisor and directs the user to their respective user category page. WebSS will display invalid credentials for unauthorized users. For example if the user is client, WebSS loads all the data such as monitor scheduled batches, chat page etc that is related to that particular client ID.

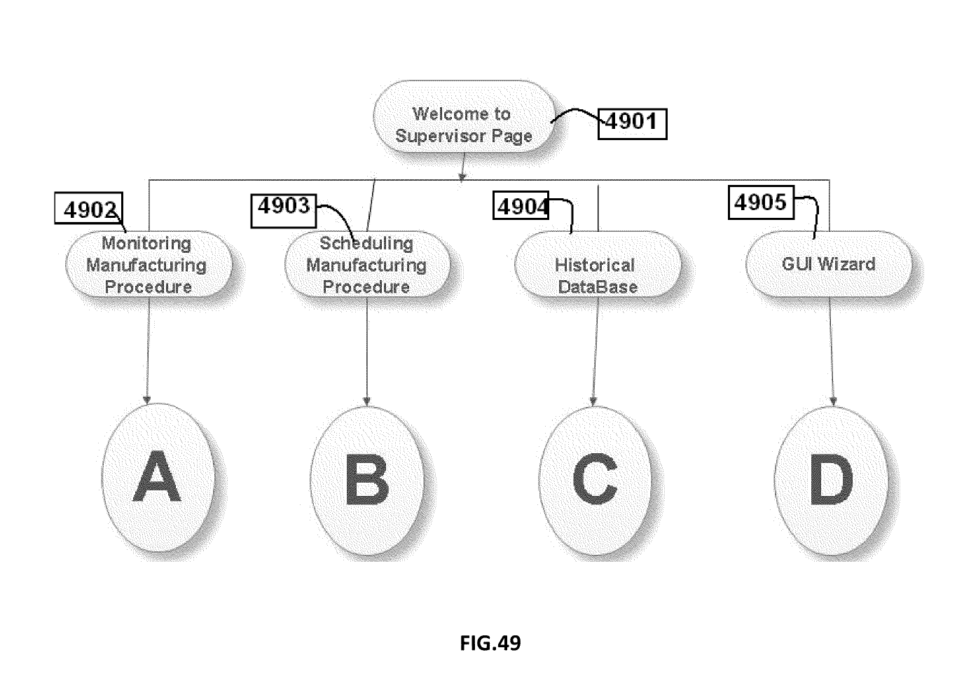

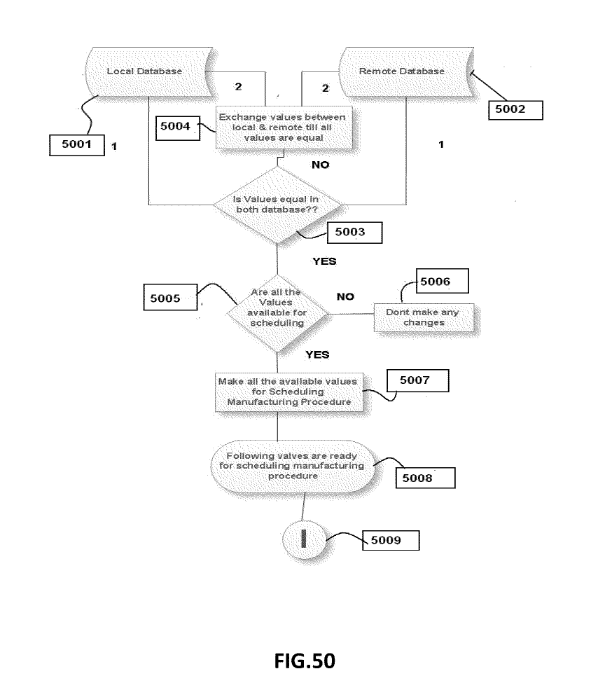

FIG. 49 shows the main functionalities of Supervisor Scheduler that is ability to schedule a task 4903, ability to monitor a task 4902, ability to analyze a task 4904. The procedure involved in each task is explained in following document.

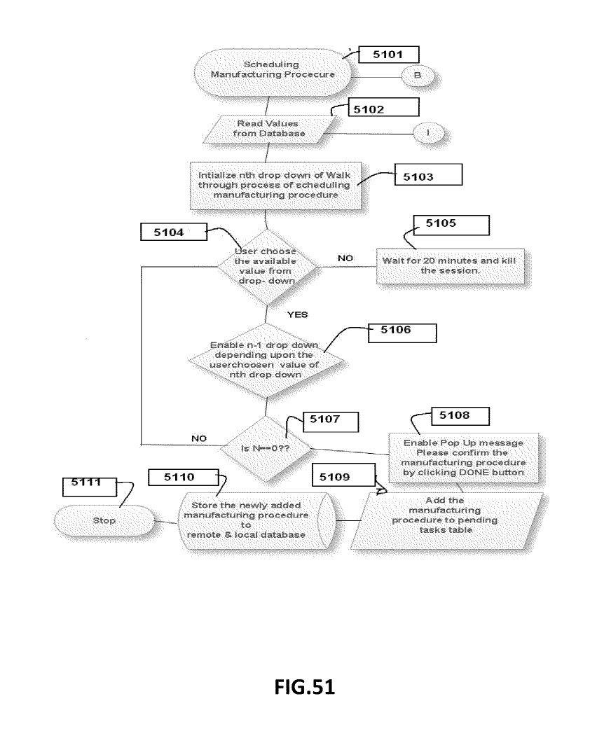

FIG. 50 illustrates the loop procedure that is stated in FIG. 5.5.2 how information is transferred with the Supervisor/Scheduler. This loop runs in the backend 24/7 invisible to users both in WebSS and localSS synchronously every 60 seconds. The principal purpose of the process is to assure that all the databases in the cloud 5002 and all the databases in the local network 5001 i.e. at client manufacturing site is equivalent 5003. If the values are not equivalent loop procedure continues till all the values are equivalent. If the values are equivalent, then all the values are made available for the next scheduling manufacturing procedure 5008.

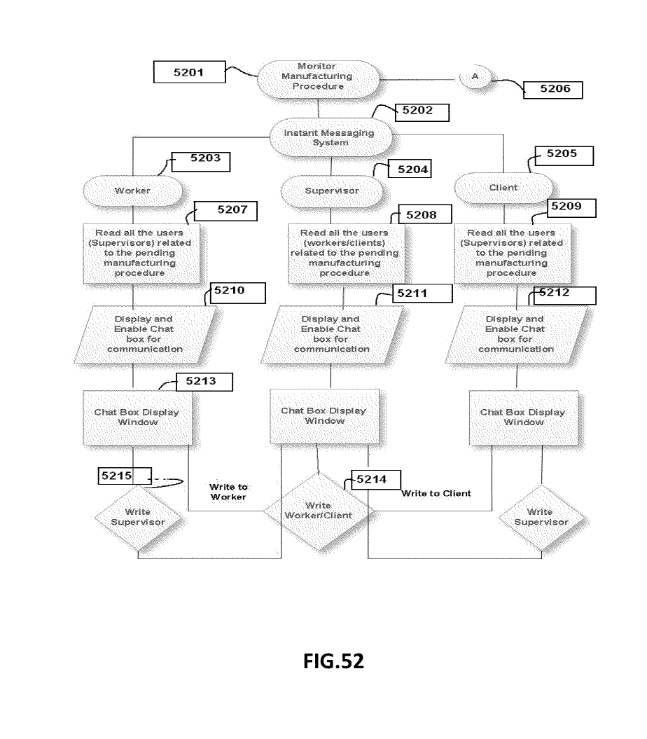

FIG. 51 illustrates the scheduling of a manufacturing procedure, starting at 5101. Initially, at 5102, the background process makes all the values available for the user. At 5103 a walkthrough of the process is enabled. At 5104, the user may choose an available value but is deliberately constrained by prior selections—one of the purposes of the Supervisor/Scheduler. If neither the user nor the browser does not provide input over a waiting time, specified as 20 minutes 5105, the session is killed automatically and reinitiates the process from the beginning. If the user chooses a value at 5104, then at 5106, the next value may be chosen by the user. The process determines, at 5107, all the drop down choices in WebSS are chosen by user (N==0), and if so, it will deliver the scheduled manufacturing process to both local and remote stations and confirms it by sending emails to the respective users involved in the manufacturing procedure.

Rights to monitor the manufacturing procedure are distributed to three classes of user, though fewer or more classifications can readily be implemented. FIG. 52 explores the instant messenger system along these three classes. The key algorithm that governs the instant messaging system is “Only select users are permitted to chat”, i.e. the group of supervisor, workers and clients that have access rights to a particular manufacturing process. The algorithm assures that only these people can communicate with one another, thereby excluding outsiders as would be expected both for confidentiality and for efficiency of keeping out non-participating parties. The way communication takes place is described in detail in the flow chart of FIG. 52. The supervisor is able to Read/Write to workers and clients, a worker is able to Read/Write to the supervisor only, and only the messages that related to that respective worker will be shown. The functionality for clients is similar.

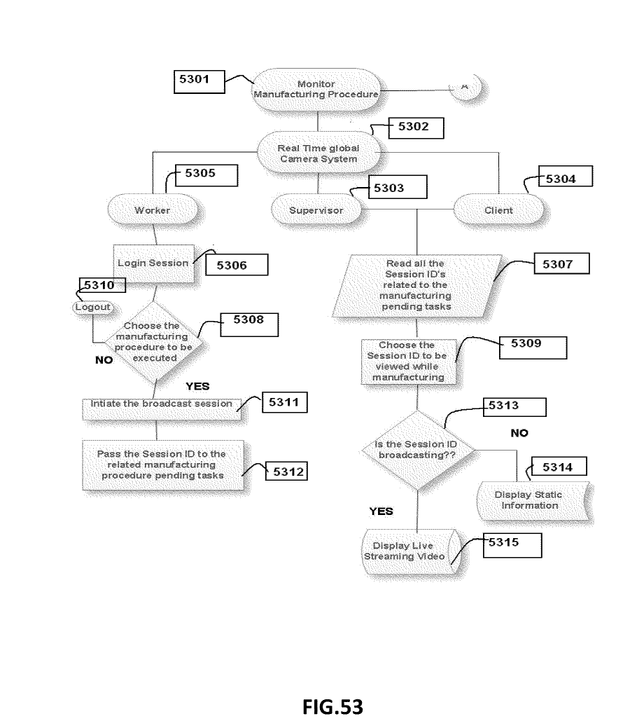

Referring to FIG. 53, when a real time global camera system is used (a subcategory of the monitoring procedure), the worker will initiate the camera broadcasting and the backend process creates a session 5312 and the supervisor and client, with respect to that manufacturing procedure, see a live transmission, i.e. the process reads the session id and they key-in their names which is a validation control at 5309 and are able to see the live session if it is streaming, at 5315.

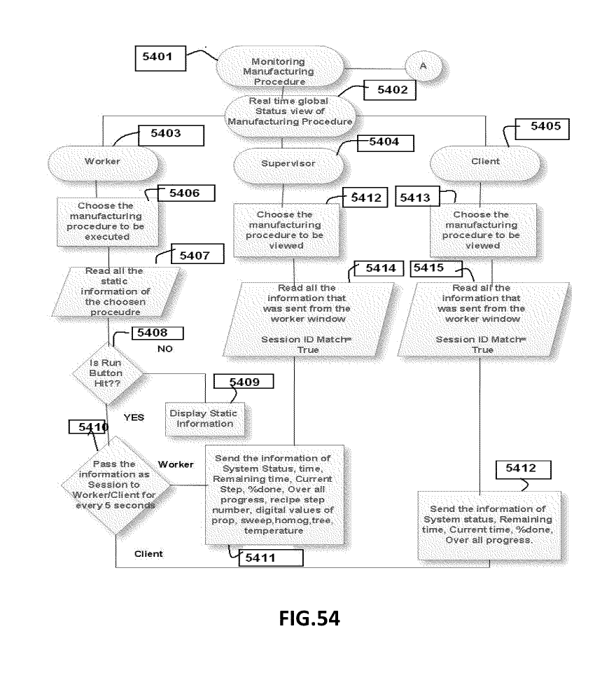

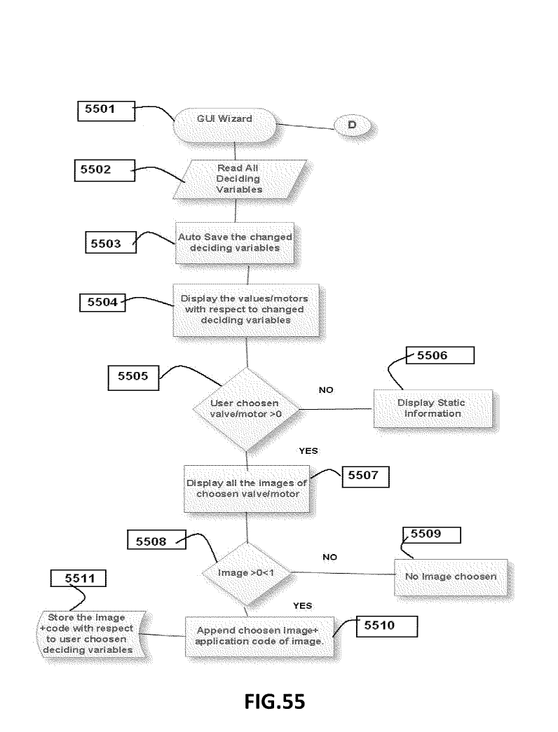

FIG. 54 is a subcategory of Monitor Manufacturing Procedure, i.e. a real time global status update system. At 5408, the process checks if a worker is running the procedure. Once the process is identified, the worker hits a run button, transmission of digital values, system status etc. will be sent from the local database to the remote database every five seconds, at 5410, and the supervisor will access data, at 5410, via the remote database. The backend process assures that the data that is desired by that user is transmitted. In the case of the client, backend process only sends a part of the data 5410 to the client page, at 5412.

Referring to FIG. 55, the Supervisor Scheduler has a customizable GUI. i.e. the user can modify the icons that appear in the browser page as well as the worker page. Upon initiation, all the deciding variables are read at 5502. The user can choose different images available from the database at 5507. Once user confirms that this is the design look for that specified location, it is stored permanently in the remote database as those values for that location only. All other locations have default icons or another custom design as defined by the user. At the backend, each icon is seen as code and specific code of each image is the driving force for the hardware to turn on and off, at 5511.

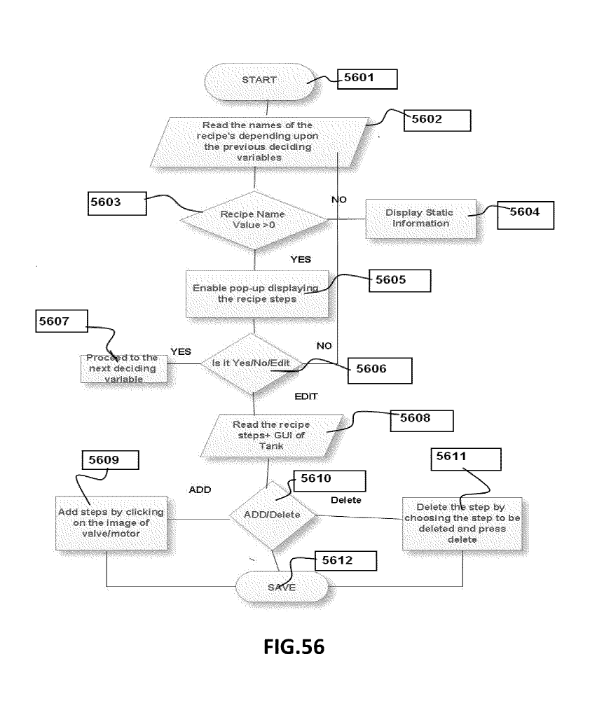

Due to day-to-day change in manufacturing procedure i.e. the same procedure for a specific day may vary in quantities and the user is able to edit the quantities or the way manufacturing instructions should run i.e. swapping instructions in manufacturing procedure. As an example, the user may make high pulp orange one day with the same instructions and another day no pulp orange juice. In this scenario, mixing instructions may need to change. This result can be achieved in the Recipe Wizard FIG. 56. Once the user chooses the recipe name, recipe name value >0 at 5603, the browser/process enables a pop-up screen displaying a set of instructions involved in that manufacturing procedure at 5608. The user can modify the recipe by adding new step at 5609; i.e. simply clicking on the image will write the necessary action step inside the recipe editor box automatically. Deleting a step, at 5611, is achieved by simply choosing the step and pressing delete. The process is saved at 5612. The entire change in recipe instructions i.e. manufacturing procedure is saved and the databases of remote and respective local station are immediately updated, generally in less than 30 milliseconds, using communications as in FIG. 45.

In summary, the Supervisor Scheduler may be implemented as Web-based software running on a server accessed by the all the browsers (safari, Google chrome, Mozilla Firefox, Internet Explorer etc) of PC, Notebooks, PDA & Smartphone's to:
1. Schedule a task (manufacturing procedure) including making of recipe's—Real Time instant global accessibility
2. Monitoring of task—Real time instant global accessibility
3. Analyzing of task—Real Time instant global accessibility
4. Repeatability and virtual comparison of previous tasks to the present running similar task—Real time instant global accessibility
5. Enabling wise communication chat—Real time instant global accessibility
6. Multitasking (scheduling, monitoring, analyzing, repeatability, virtual comparison, wise communication) of different tasks not only a particular location but between different locations of the factory—Real time instant global accessibility.
7. Storing the data, processing the data & analyzing the data—Real time instant global accessibility. For hardware's such as DART, PLC & PAC etc.

The Supervisor Scheduler uses twenty first century complicated communication technology and gives to the user a simple interface but is powerful in controlling the factory. The Supervisor Scheduler may have database as its backbone, which guides the user Step by Step in scheduling a task. The Scheduler allows the user to customize his screen day to day according to the present day needs, such as what gadgets the user needs to monitor today, build new gadgets etc. The Supervisor Scheduler is a 24/7 365 day approach to monitoring via WEB the local station in highly secured manner and reporting back securely to the users who are globally spread. The Supervisor Scheduler is the same whether it controls PLC, DART or PAC control system; user's will not note any difference. Even in the case of the Web being down, the Supervisor Scheduler has the ability to make the local station run without interruption and when web the is up again, its retrieves the data from local station, broadcasts globally and is synchronized automatically. Unlimited control of local stations in real time is possible.

In accordance with yet another aspect of the invention, it has been noted that the vast majority of manufacturing companies in the chemical process sector are small entities with fewer than 250 employees, and as noted above, often with less than 50 employees. One goal of the invention is to enable these small businesses to have much of the automation advantages that their large competitors can afford. Much automation technology relies on the sophisticated skills of specialized programmers and systems engineers. By reducing the need for such skilled labor, the invention allows a broader distribution of companies to benefit from the efficiencies inherent in predictable, repeatable, and auditable manufacturing.

The PC-based software operates with an intuitive structure that allows the worker to apply his fundamental factory skills, ones generally acquired by practiced manual labor, to easily generate a programmed sequence of instructions.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

TABLE 1
Engines

| Engine Type | Arduino | PLC | Ontrak Board | Field I/O |
|---|---|---|---|---|
| Communication to | USB | Serial or Ethernet | Serial | Ethernet |
| PC | communication | communication | communication | communication |
| | cable | cable | cable | cable. |
| Digital Output | 12 V Solenoid | 12 V Solenoid | 12 V Solenoid | 12 V Solenoid |
| | Valve | Valve | Valve | Valve |
| Digital Input | Water fill level | Water fill level | Water fill level | Water fill level |
| | limit switch | limit switch | limit switch | limit switch |
| Analog Read | Analog | Analog | Analog | Analog |
| | Thermocouple | Thermocouple | Thermocouple | Thermocouple |
| Analog Write | DC Motor | DC Motor | DC Motor | DC Motor |
| Digital Output | 12 V Relay | 12 V Relay (Built | 12 V Relay (Built | 12 V Relay (Built in |
| accessory | | into PLC on some | into Board) | on some models) |
| | | Models) | | |
| Digital Input | Limit switch logic | | Limit switch logic | |
| accessory | level converter | | level converter | |
| Analog Read | Analog | | Analog | |
| accessory | Thermocouple | | Thermocouple | |
| | amplifier | | transmitter | |
| Analog Write | 36 V Analog Motor | 36 V Analog Motor | 36 V Analog Motor | 36 V Analog Motor |
| accessory | controller(PWM) | controller(4- | controller(PWM) | controller (4- |
| | | 20 mA) | | 20 mA) |

TABLE 2
Pin address and meaning.

| Address | Meaning |
|---|---|
| O: 0/0 | O stands for output, 0 stands for the first |
| | block, 0 stands for the first channel. The |
| | “/” indicates digital signal. |
| I: 0/0 | I stands for input, 0 stands for the first |
| | block, 0 stands for the first channel. The |
| | “/” indicates digital signal. |
| O: 0.0 | O stands for output, 0 stands for the first |
| | module, 0 stands for first channel. The “.” |
| | indicates analog signal. |
| I: 0.0 | I stands for input, 0 stands for the fourth |
| | block, 0 stands for the first channel. The “.” |
| | indicates analog signal. |

TABLE 3
Addresses and possible values to be
written or read to and from the PLC.

| Address | Value Written/Read |
|---|---|
| O: 0/0 | 1 (On) 0 (Off) |
| I: 0/0 | (Read) 1/0 |
| O: 0.0 | 0-5 V (analog output) |
| I: 0.0 | 0-65535 (analog input) |

TABLE 4
Addresses and possible values to be written
or read to and from the Field I/O.

| Address | Value Written/Read |
|---|---|
| DO, 1 | 1 (On) 0 (Off) |
| DI, 10001 | (Read) 1/0 |
| AO, 30001 | 0-5 V (analog output) |
| AI, 20001 | 0-8192 (analog input) |

TABLE 5
Arduino sample table of information entered by the user in the Wizard software.
Configuration file ARDUINO

| UDI configuration file | | | Main Configuration File | | |
|---|---|---|---|---|---|
| | | Pin | Hardware Type, | | Function |
| Unique Name | Pin | Mode | Make and Model | State Logic | controlling |
| Solenoid Valve 1 | 1 | Digital | Valve, ANA Model | LOW is off | Steam |
| | | Output | 101 | | |
| Fill limit switch 7 | 2 | Digital | Switch, | HIGH is active | Fill Level |
| | | Input | ACME #7 | | |
| Thermal couple (the | 16 | Analog | Thermocouple, | Scale 0-200 mv | Temperature |
| one Joe got) | | Input | Omega type J | to 0 K-375 K | |
| DC motor | 3 | Analog | DC Motor, | Scale 0-255 | Mixer Speed |
| 2pojf934@# | | Output | Makita 2M033 | to 0-100% Power | |

TABLE 6
PLC Sample table of information entered by the user in the Wizard software
Configuration file PLC

| UDI configuration file | | | Main Configuration File | | |
|---|---|---|---|---|---|
| | | Pin | Hardware Type, | | Function |
| Unique Name | Pin | Mode | Make and Model | State Logic | controlling |
| Solenoid Valve 1 | O: 0/0 | Digital | Valve, ANA Model | LOW is off | Steam |
| | | Output | 101 | | |
| Fill limit switch 7 | I: 0/0 | Digital | Switch, | HIGH is active | Fill Level |
| | | Input | ACME #7 | | |
| Thermal couple (the | I: 0.0 | Analog | Thermocouple, | Scale 0-200 mv | Temperature |
| one Joe got) | | Input | Omega type J | to 0 K-375 K | |
| DC motor | O: 0.0 | Analog | DC Motor, | Scale 4-20 mA | Mixer Speed |
| 2pojf934@# | | Output | Makita 2M033 | to 0-100% Power | |

TABLE 7
Ontrak Sample table of information entered by the user in the Wizard software.
Configuration file Ontrak

| UDI configuration file | | | Main Configuration File | | |
|---|---|---|---|---|---|
| | | Pin | Hardware Type, | | Function |
| Unique Name | Pin | Mode | Make and Model | State Logic | controlling |
| Solenoid Valve 1 | PA1 | Digital | Valve, ANA Model | LOW is off | Steam |
| | | Output | 101 | | |
| Fill limit switch 7 | PA2 | Digital | Switch, | HIGH is active | Fill Level |
| | | Input | ACME #7 | | |
| Thermal couple (the | AN0 | Analog | Thermocouple, | Scale 0-200 mv | Temperature |
| one Joe got) | | Input | Omega type J | to 0 K-375 K | |
| DC motor | PWMA | Analog | DC Motor, | Scale 0-1024 | Mixer Speed |
| 2pojf934@# | | Output | Makita 2M033 | to 0-100% Power | |

TABLE 8
Field I/O Sample table of information entered by the user in the Wizard software.
Configuration file Field I/O

| UDI configuration file | | | Main Configuration File | | |
|---|---|---|---|---|---|
| | | Pin | Hardware Type, | | Function |
| Unique Name | Pin | Mode | Make and Model | State Logic | controlling |
| Solenoid Valve 1 | DO, 1 | Digital | Valve, ANA | LOW is off | Steam |
| | | Output | Model 101 | | |
| Fill limit switch 7 | DI, 10001 | Digital | Switch, | HIGH is active | Fill Level |
| | | Input | ACME #7 | | |
| Thermal couple (the | AI, 20001 | Analog | Thermocouple, | Scale 0-200 mv | Temperature |
| one Joe got) | | Input | Omega type J | to 0 K-375 K | |
| DC motor | AO, 30001 | Analog | DC Motor, | Scale 4-20 mA | Mixer Speed |
| 2pojf934@# | | Output | Makita 2M033 | to 0-100% Power | |

TABLE 9
Sample information entered by the User in the GUIB

| | | | | |
|---|---|---|---|---|
| Unique Name: | Solenoid Valve 1 | Fill limit | Thermal couple | DC motor |
| | | switch 7 | (the one Joe got) | 2pojf934@# |
| Name on Gui: | Steam Valve on | Fill limit | Temperature | Main mixer |
| | right | indicator | Gauge | |
| Physical Location/ | Top right of | 1 foot from | Immersed in | Top of tank |
| Appearance: | tank, colored | top of tank | middle of tank | |
| | blue | | | |

What is claimed is:

1. A computerized method of offering a comprehensive control system for generating consistent measurable results in varied kinds of manufacturers, comprising:
a computer graphical user interface displaying the status of hardware systems, information and status of the control system and automation of procedural commands;
a hardware database containing 1) port database including all ports of DART controller connecting to manufacturing devices, 2) device database including information, operation methods, operational history of all devices connected to the DART controller, 3) system database including information and configuration of all systems under controller control;
a user programmable dictionary containing natural language that defines and enables operations and status of every device; and
a background subroutine responsible for polling and refreshing data from the port database in milliseconds.

2. The method of claim 1, wherein different languages are accessible and supported using the dictionary.

3. The method of claim 1, further comprising: the ability to simultaneously control multiple systems, and/or different kinds of system, such as tank systems for chemical manufactures, motor systems in motion control, and others in real time.

4. The method of claim 1, further comprising: communicating with different kinds of control devices other than the DART controller, such as Allen Bradley DF-1, Allen Bradley Ethernet/IP, Siemens PPI/MPI, and others, by a universal communication interface.

5. The method of claim 1, further comprising: a status and emergency control procedure within the background subroutine to preprocess logical data comparisons against normative parameters before user initiates a command and to enable priority settings on prescribed routines when certain logical conditions are satisfied.

6. A computerized method for a comprehensive and sequential automation procedures for generating consistent measurable results in varied kinds of manufacturers, comprising:
an editor to build graphics or texts to describe the automation procedure, such as recipes for chemical process, flow charts of process control and any manufacturing process;
a translator to translate the natural language or graphics into a command or commands that a computer can execute on the fly;
a runtime processor responsible for running automation procedure; and
a graphic user interface module to express and control the automation procedure.

7. The method of claim 6, wherein different languages are accessible and supported using the dictionary.

8. The method of claim 6, further comprising: macros and subroutines that independently run segments of a process during the running of the main process.

9. The method of claim 6, further comprising: updating dynamic information to a web server in real time to allow clients to watch their product being made and monitor their product's status in real time.

10. The method of claim 6, further comprising: a wizard to enable users to input hardware configurations into the hardware database to build their own interactive graphic user interface.

11. A computer system configured to perform the method of claim 1.

12. A computer readable medium have thereon computer readable instructions for performing the method of claim 1.

13. A computerized method of offering a comprehensive control system for varied kinds of manufactures, comprising: providing a computer graphical user interface having the static model of hardware systems, information and status of the control system and context of the automation procedure commands; providing a hardware database containing 1) port database including all ports of DART controller connecting to devices, 2) device database including information, operation methods, events of all devices connected to the DART controller, 3) system database including information and configuration of all systems that controller controls; providing a dictionary containing word pairs that define operations and status of every device; providing a background worker responsible for refreshing data from port database every some milliseconds.

14. A computer system configured to perform the method of claim 13.

15. A computer readable medium have thereon computer readable instructions for performing the method of claim 14.
